(19) United States
(12) Patent Application Publication
(10) Pub. No.: US 2026/0370813 A1
(43) Pub. Date: Nov. 19, 2026

(54) PREDICTION IMAGE GENERATION APPARATUS, VIDEO DECODING APPARATUS, VIDEO CODING APPARATUS, AND PREDICTION IMAGE GENERATION METHOD

(71) Applicant: SHARP KABUSHIKI KAISHA, Sakai City, Osaka (JP)

(72) Inventors: Zheming FAN, Sakai City, Osaka (JP); TOMOHIRO IKAI, Sakai City, Osaka (JP); YUKINOBU YASUGI, Sakai City, Osaka (JP); TOMOKO AONO, Sakai City, Osaka (JP)

(21) Appl. No.: 19/138,714

(22) PCT Filed: Nov. 17, 2023
(86) PCT No.: PCT/JP2023/041397

§ 371 Date: Jun. 13, 2025

(30) Foreign Application Priority Data
Dec. 16, 2022 (JP) 2022-201548
Mar. 6, 2023 (JP) 2023-033764

(51) Int. Cl. H04N 19/11; H04N 19/105; H04N 19/176; H04N 19/70

(52) U.S. Cl. CPC H04N 19/11; H04N 19/105; H04N 19/176; H04N 19/70

(57) ABSTRACT

Improving the accuracy of DIMD and DIMD CHROMA method for intra prediction without additional costs. The weight, size, and shape of the filter used to derive the gradient may be changed according to the size and shape of the target block.

### TECHNICAL FIELD

The embodiments of the present invention relate to a prediction image generation apparatus, a video decoding apparatus, a video coding apparatus, and a prediction image generation method.

### BACKGROUND ART

A video coding apparatus which generates coded data by coding a video, and a video decoding apparatus which generates decoded images by decoding the coded data are used for efficient transmission or recording of videos.

For example, specific video coding schemes include H.264/AVC, High-Efficiency Video Coding (HEVC), and Versatile Video Coding (VVC) schemes, and the like.

In such a video coding scheme, images (pictures) constituting a video are managed in a hierarchical structure including slices obtained by splitting an image, coding tree units (CTUs) obtained by splitting a slice, units of coding (coding units; which will be referred to as CUs) obtained by splitting a coding tree unit, and transform units (TUs) obtained by splitting a coding unit, and are coded/decoded for each CU.

In such a video coding scheme, usually, a prediction image is generated based on a local decoded image that is obtained by coding/decoding an input image (a source image), and prediction error components (which may be referred to also as “difference images” or “residual images”) obtained by subtracting the prediction image from the input image are coded. Generation methods of prediction images include an inter-picture prediction (an inter-prediction) and an intra-picture prediction (intra prediction).

In recent video coding and decoding technique, a Decoder-side Intra Mode Derivation (DIMD) prediction method is proposed by NPL1, in which the decoder derives the prediction image by deriving the intra angular prediction mode using pixels in adjacent regions for luma prediction. Furthermore, NPL2 proposes a improvement on DIMD method, in which using different reference region for predicting. Furthermore, NPL3 proposes method using DIMD method for chroma prediction.

### CITATION LIST

### Non Patent Literature

NPL 1: M. Abdoli, T. Guionnet, E. Mora, et. al, “Non-CE3: Decoder-side Intra Mode Derivation with Prediction Fusion Using Planar”, JVET-00449, Gothenburg, July 2019.
NPL 2: Z. Fan, Y. YASUGI, T. IKAI, “Non-EE2: Adaptive reference region DIMD”, JVET-AB0065, Mainz, DE, 20-28 Oct. 2022 NPL 3: X. Li, R. Liao, J, Chen, Y. Ye, “Non-EE2: On chroma intra prediction mode,” JVET-Y0092, Teleconference, 12-21 Jan. 2022.

### SUMMARY OF INVENTION

### Technical Problem

The intra mode is derived on the decoder side using the gradient of pixel values in different neighboring regions. But in NPL2, there is a problem that the prediction angle of neighboring blocks may not be consistent with the prediction angle of target block. And the size and the value of the derivation filter used in NPL1 and NPL3 are fixed and this is not the best choosing for some situations.

This invention aims at improving the accuracy by deriving different filters and switching the filters which are used for calculating gradients in accordance with the size of target block in the decoder side intra mode derivation.

### Solution to Problem

The adaptive reference region DIMD (NPL2) method allows the selection of reference regions with three patterns: 1: using top-left, top, and left neighboring regions. 2: using top-left, top, and top-right neighboring regions. 3: using top-left, left, and left-bottom neighboring regions. named DIMD_TL, DIMD_T, and DIMD_L, respectively.

The DIMD (NPL1) and DIMD CHROMA (NPL3) method derive the intra prediction direction by using the gradient of pixel values in different neighboring regions for luma and chroma prediction, respectively.

A filter selection unit 3104611 is included in a gradient derivation unit 310461. The filter selection unit 3104611 chooses filter based on the sizeof target block.

The filter selection unit 3104611 is characterized by using different filter for the target block with different size.

### Advantageous Effects of Invention

According to an aspect of the present invention, the amount of calculation for intra prediction mode derivation can be reduced while limiting a coding loss and the quality of the codecs can be improved without adding additional calculations.

### BRIEF DESCRIPTION OF DRAWINGS

FIG. 1 is a schematic diagram illustrating a configuration of an image transmission system according to the present embodiment.

FIG. 2 is a diagram showing the hierarchical structure of the coded stream data.

FIG. 3 is a schematic diagram showing the type of intra-prediction mode (mode number).

FIG. 4 is a schematic diagram of the video decoder.

FIG. 5 is an example of DIMD syntax.

FIG. 6 is a figure of the binaryization of the dimd_mode syntax used in the DIMD prediction unit 31046.

FIG. 7 is another example of DIMD syntax.

FIG. 8 shows the structure of the intra prediction image generation unit 310.

FIG. 9 is a diagram showing the details of the DIMD prediction unit 31046.

FIG. 10 shows an example of the reference region referred to by the DIMD prediction unit 31046.

FIG. 11 shows an example of a set of spatial filters.

FIG. 12 shows an example of a target pixel for gradient derivation when using 3×3 filter.

FIG. 13 shows example of a target pixel for gradient derivation when using 2×2 filter.

FIG. 14 shows examples of a target pixel for gradient derivation when using 2×2 filter.

FIG. 15 is a block diagram illustrating the relationship between the gradient and the region.

FIG. 16 is a block diagram showing the structure of the angle derivation unit.

FIG. 17 shows examples of the reference region used for gradient derivation of the DIMD prediction unit 31046.

FIG. 18 is a block diagram showing an example of the configuration of the inverse quantization and inverse transform processing unit 311.

FIG. 19 is a block diagram showing the structure of a video coding system.

FIG. 20 is a diagram showing the details of the DIMD CHROMA prediction unit 31047.

FIG. 21 shows an example of the reference region referred to by the DIMD prediction unit 31046.

FIG. 22 shows some examples of the filter used for gradient derivation.

FIG. 23 shows some examples of the filter used for gradient derivation.

FIG. 24 shows examples of gradient derivation pixels for gradient derivation when using filter.

FIG. 25 shows examples of gradient derivation pixels for gradient derivation when using filter.

FIG. 26 shows an example of the reference region used for gradient derivation of the DIMD prediction unit 31046.

FIG. 27 is a block diagram showing the structure of the angular mode derivation device 310475.

FIG. 28 shows examples of the reference region used for gradient derivation of the DIMD CHROMA prediction unit 31047.

### DESCRIPTION OF EMBODIMENTS

### First Embodiment

Hereinafter, embodiments of the present disclosure will be described with reference to the drawings.

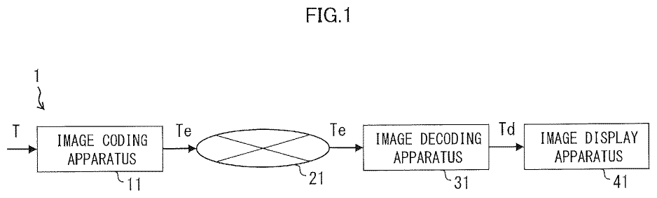

FIG. 1 is a schematic diagram illustrating a configuration of an image transmission system 1 according to the present embodiment.

The image transmission system 1 is a system in which a coding stream obtained by coding a coding target image is transmitted, the transmitted coding stream is decoded, and an image is displayed. The image transmission system 1 includes a video coding apparatus (image coding apparatus) 11, a network 21, a video decoding apparatus (image decoding apparatus) 31, and a video display apparatus (image display apparatus) 41.

An image T is input to the video coding apparatus 11.

The network 21 transmits a coding stream Te generated by the video coding apparatus 11 to the video decoding apparatus 31. The network 21 is the Internet, a Wide Area Network (WAN), a Local Area Network (LAN), or a combination thereof. The network 21 is not necessarily limited to a bidirectional communication network, and may be a unidirectional communication network configured to transmit broadcast waves of digital terrestrial television broadcasting, satellite broadcasting or the like. Furthermore, the network 21 may be substituted by a storage medium in which the coding stream Te is recorded, such as a Digital Versatile Disc (DVD: trademark) or a Blu-ray Disc (BD: trademark).

The video decoding apparatus 31 decodes each of the coding streams Te transmitted from the network 21 and generates one or multiple decoded images Td which are decoded.

The video display apparatus 41 displays all or part of the one or multiple decoded images Td generated by the video decoding apparatus 31. For example, the video display apparatus 41 includes a display device such as a liquid crystal display and an organic Electro-Luminescence (EL) display. Forms of the display include a stationary type, a mobile type, an HMD type, and the like. In addition, in a case that the video decoding apparatus 31 has a high processing capability, an image having high image quality is displayed, and in a case that the apparatus only has a lower processing capability, an image which does not require high processing capability and display capability is displayed.

### Operator

Operators and notations used in the present specification will be described below.

>> is an arithmetic right bit shift, << is an arithmetic left bit shift, & is a bitwise AND, | is a bitwise OR, \hat{ } is a bitwise XOR, |= is an OR assignment operator, and ∥ indicates a logical sum.

x?y:z is a ternary operator to take y in a case that x is true (other than 0) and take z in a case that x is false (0).

Clip3(a, b, c) is a function to clip c in a value equal to or greater than a and less than or equal to b, and a function to return a in a case that c is less than a (c<a), return b in a case that c is greater than b (c>b), and return c in other cases (provided that a is less than or equal to b (a<=b)).

abs(a) is a function that returns the absolute value of a.

Int(a) is a function that returns the integer value of a.

floor(a) is a function that returns the maximum integer equal to or less than a.

ceil(a) is a function that returns the minimum integer equal to or greater than a.

a/d represents division of a by d (round down decimal places).

x=y . . . z represents x takes on integer values starting from y to z, inclusive, with x, y, and z being integer numbers and z being greater than or equal to y.

### Structure of Coding Stream Te

Prior to the detailed description of the video coding apparatus 11 and the video decoding apparatus 31 according to the present embodiment, a data structure of the coding stream Te generated by the video coding apparatus 11 and decoded by the video decoding apparatus 31 will be described.

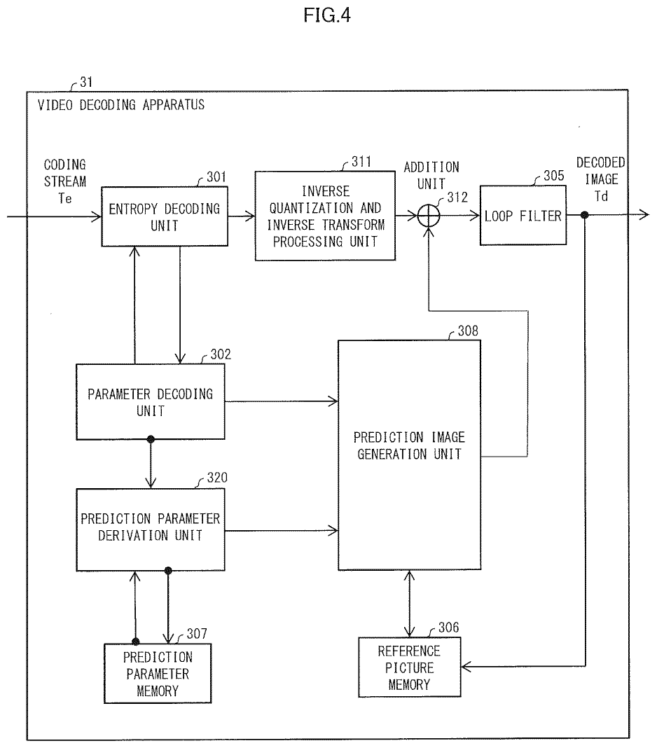

FIG. 4 is a diagram illustrating a hierarchical structure of data of the coding stream Te. The coding stream Te includes a sequence and multiple pictures constituting the sequence illustratively. (a) to (f) of FIG. 4 are diagrams illustrating a coded video sequence defining a sequence SEQ, a coded picture prescribing a picture PICT, a coding slice prescribing a slice S, a coding slice data prescribing slice data, a coding tree unit included in the coding slice data, and a coding unit (CU) included in each coding tree unit, respectively.

### Coded Video Sequence

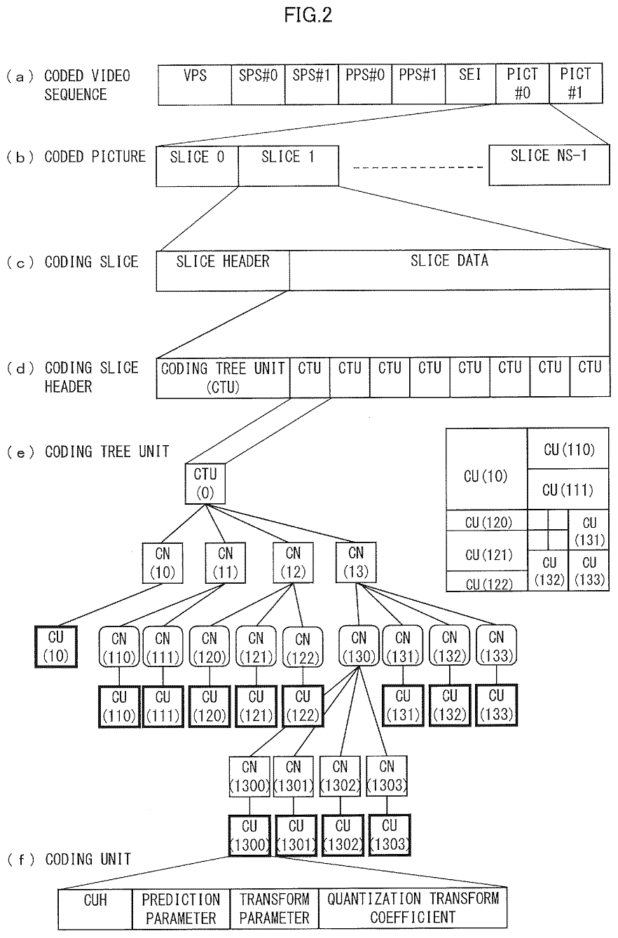

In the coded video sequence (CVS, coding stream), a set of data referred to by the video decoding apparatus 31 to decode the CVS to be processed is defined. As illustrated in FIG. 2, the CVS includes a Video Parameter Set (VPS), a Sequence Parameter Set (SPS), a Picture Parameter Set (PPS), a picture (PICT), and Supplemental Enhancement Information (SEI).

In the video parameter set VPS, in a video including multiple layers, a set of coding parameters common to multiple videos and a set of coding parameters associated with the multiple layers and an individual layer included in the video are defined.

In the sequence parameter set SPS, a set of coding parameters referred to by the video decoding apparatus 31 to decode a target sequence is defined. For example, a width and a height of a picture are defined. Note that multiple SPSs may exist. In that case, any of multiple SPSs is selected from the PPS.

In the picture parameter set PPS, a set of coding parameters referred to by the video decoding apparatus 31 to decode each picture in a target sequence is defined. For example, a reference value (pic_init_qp_minus26) of a quantization step size used for decoding of a picture and a flag (weighted_pred_flag) indicating an application of a weighted prediction are included. Note that multiple PPSs may exist. In that case, any of multiple PPSs is selected from each picture in a target sequence.

### Coded Picture

In the coded picture, a set of data referred to by the video decoding apparatus 31 to decode the picture PICT to be processed is defined. As illustrated in FIG. 2, the picture PICT includes a slice 0 to a slice NS−1 (NS is the total number of slices included in the picture PICT).

Note that in a case that it is not necessary to distinguish each of the slice 0 to the slice NS−1 below, subscripts of reference signs may be omitted. In addition, the same applies to other data with subscripts included in the coding stream Te which will be described below.

### Coding Slice

In the coding slice, a set of data referred to by the video decoding apparatus 31 to decode the slice S to be processed is defined. As illustrated in FIG. 2, the slice includes a slice header and a slice data.

The slice header includes a coding parameter group referred to by the video decoding apparatus 31 to determine a decoding method for a target slice. Slice type specification information (slice_type) indicating a slice type is one example of a coding parameter included in the slice header.

Examples of slice types that may be specified by the slice type specification information include (1) I slice using only an intra prediction in coding, (2) P slice using a unidirectional prediction or an intra prediction in coding, and (3) B slice using a unidirectional prediction, a bidirectional prediction, or an intra prediction in coding, and the like. Note that the inter prediction is not limited to a uni-prediction and a bi-prediction, and the prediction image may be generated by using a larger number of reference pictures. Hereinafter, in a case that a slice is referred to as the P or B slice, the slice indicates a slice that includes a block in which the inter prediction may be used.

Note that, the slice header may include a reference to the picture parameter set PPS (pic_parameter_set_id).

### Coding Slice Data

In the coding slice data, a set of data referred to by the video decoding apparatus 31 to decode the slice data to be processed is defined. The slice data include CTUs as illustrated in FIG. 2. The CTU is a block of a fixed size (for example, 64×64) constituting a slice, and may be called a Largest Coding Unit (LCU).

### Coding Tree Unit

In FIG. 2, a set of data referred to by the video decoding apparatus 31 to decode the CTU to be processed is defined. The CTU is split into coding units CUs, each of which is a basic unit of coding processing, by a recursive Quad Tree split (QT split), Binary Tree split (BT split), or Ternary Tree split (TT split). The BT split and the TT split are collectively referred to as a Multi Tree split (MT split). Nodes of a tree structure obtained by recursive quad tree splits are referred to as Coding Nodes. Intermediate nodes of a quad tree, a binary tree, and a ternary tree are coding nodes, and the CTU itself is also defined as the highest coding node.

### Coding Unit

As illustrated in FIG. 2, a set of data referred to by the video decoding apparatus 31 to decode the coding unit to be processed is defined. Specifically, the CU includes a CU header CUH, a prediction parameter, a transform parameter, a quantization transform coefficient, and the like. In the CU header, a prediction mode and the like are defined.

There are cases that the prediction processing is performed in units of CU or performed in units of sub-CU obtained by further splitting the CU. In a case that the sizes of the CU and the sub-CU are equal to each other, the number of sub-CUs in the CU is one. In a case that the CU is larger in size than the sub-CU, the CU is split into sub-CUs. For example, in a case that the CU has a size of 8×8, and the sub-CU has a size of 4×4, the CU is split into four sub-CUs which include two horizontal splits and two vertical splits.

There are two types of predictions (prediction modes), which are an intra prediction and an inter prediction. The intra prediction refers to a prediction in an identical picture, and the inter prediction refers to prediction processing performed between different pictures (for example, between pictures of different display times).

Transform and quantization processing is performed in units of CU, but the quantization transform coefficient may be subjected to entropy coding in units of subblock such as 4×4.

### Prediction Parameter

A prediction image is derived by a prediction parameter accompanying a block. The prediction parameter includes prediction parameters of the intra prediction and the inter prediction.

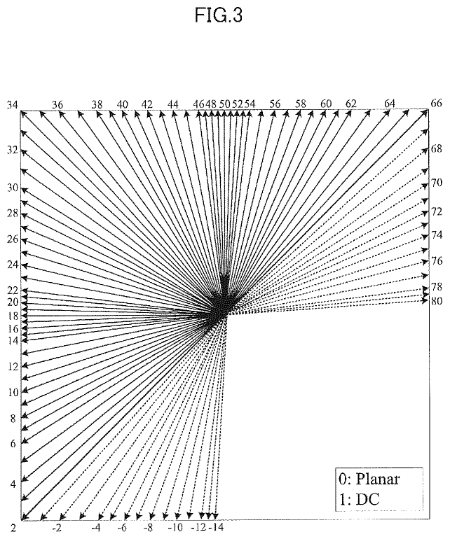

The prediction parameter of the intra prediction will be described below. The intra prediction parameter includes a luma intra prediction mode IntraPredModeY and a chroma prediction mode IntraPredModeC. FIG. 3 is a schematic diagram indicating types (mode numbers) of the intra prediction mode. As illustrated in the diagram, for example, there are 67 types (0 to 66) of intra prediction modes. For example, a planar prediction (0), a DC prediction (1), and Angular predictions (2 to 66) are present. Furthermore, for chroma, CCLM (Cross Component Linear Model) prediction mode (81 to 83), MMLM (Multi Mode Linear Model) prediction mode, and LM (Linear Model) prediction mode may be added.

### Configuration of Video Decoding Apparatus

A configuration of the video decoding apparatus 31 (FIG. 4) according to the present embodiment will be described.

The video decoding apparatus 31 includes an entropy decoding unit 301, a parameter decoding unit (prediction image decoding apparatus) 302, a loop filter 305, a reference picture memory 306, a prediction parameter memory 307, a prediction image generation unit 308, an inverse quantization and inverse transform processing unit 311, an addition unit 312, and a prediction parameter derivation unit 320. Note that a configuration in which the loop filter 305 is not included in the video decoding apparatus 31 is also used in accordance with the video coding apparatus 11 described later.

The parameter decoding unit 302 further includes a header decoding unit 3020, a CT information decoding unit 3021, and a CU decoding unit 3022 (prediction mode decoding unit), and the CU decoding unit 3022 further includes a TU decoding unit 3024. These may be collectively referred to as a decoding module. The header decoding unit 3020 decodes, from coded data, parameter set information such as the VPS, the SPS, and the PPS, and a slice header (slice information). The CT information decoding unit 3021 decodes a CT from coded data. The CU decoding unit 3022 decodes a CU from coded data. In a case that a TU includes a prediction error, the TU decoding unit 3024 decodes QP update information (quantization correction value) and a quantization prediction error (residual_coding) from coded data.

Furthermore, an example in which a CTU and a CU are used as units of processing is described below, but the processing is not limited to this example, and processing in units of sub-CU may be performed. Alternatively, by replacing the CTU and the CU by a block and replacing the sub-CU by a subblock, and processing in units of blocks or subblocks may be performed.

The entropy decoding unit 301 performs entropy decoding on the coding stream Te input from the outside and separates and decodes individual codes (syntax elements). The separated codes include prediction information to generate a prediction image, a prediction error to generate a difference image, and the like. Entropy coding has a variable length coding method for syntax elements according to the context (probability model) adaptively selected according to the type of syntax elements and the surrounding conditions, and a variable length coding method for syntax elements using a predetermined table or formula.

In the entropy decoding unit 301, for adaptive reference region DIMD(NPL2), there is a syntax element named dimd_mode. The dimd_mode is a parameter for selecting the reference region of DIMD method. The dimd_mode includes DIMD_MODE_TOP_LEFT mode, DIMD_MODE_TOP mode, and DIMD_MODE_LEFT mode. This three modes are represented by 0, 1, 2 respectively.

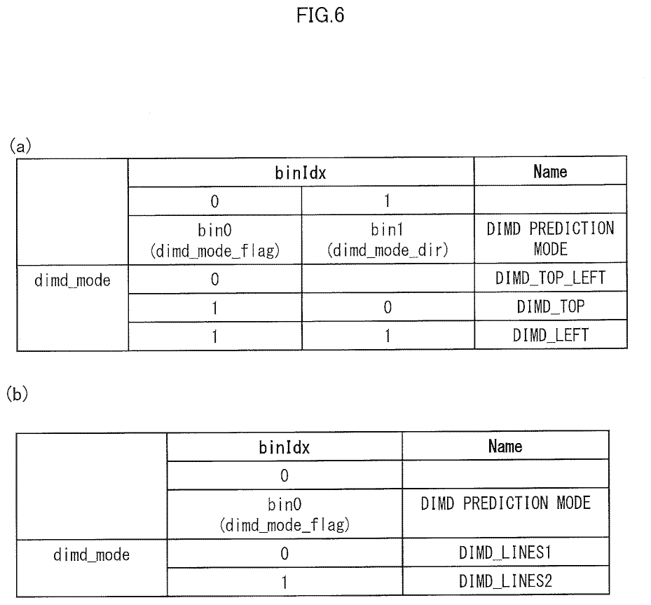

FIG. 6 shows an example of binarization of dimd_mode. In FIG. 6, the binId is a variable indicating the bit position, bin0 (binidx==0), and Bin1 (binidx==1) of the syntax element refers to the first and next bits.

Bin0 is a flag used for indicating if the DIMD_MODE_TOP_LEFT is selected. When Bin0 is 0, the DIMD_MODE_TOP_LEFT mode will be selected, and when Bin0 is 1, the DIMD_MODE_TOP_LEFT mode will not be selected.

Bin1 is a flag used for indicating which one of DIMD_MODE_TOP mode and DIMD_MODE_LEFT mode is selected. When Bin1 is 0, DIMD_MODE_TOP mode will be selected, and when Bin1 is 1, the DIMD_MODE_LEFT mode will be selected.

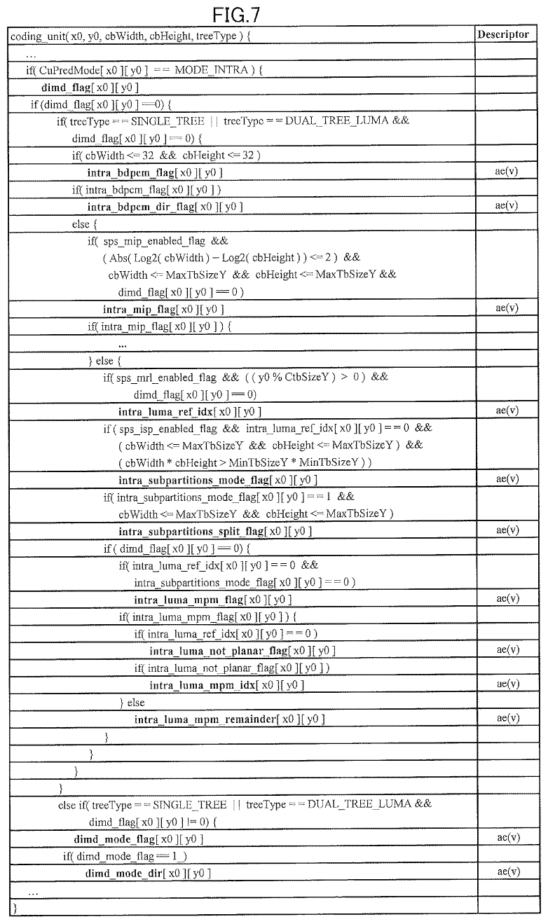

In addition, it is worth noting that Bin0 and Bin1 are not used to form one syntax element, but to assign a syntax element to Bin0 and Bin1 respectively. So dimd_mode can perspective two syntax elements. Here, the syntax element assigned to Bin0 is named dimd_mode_flag, the syntax element assigned to Bin1 is named dimd_mode_dir (shown in FIG. 7). In this case, the entropy decoding unit 301 can get the dimd_mode from dimd_mode_flag and dimd_mode_dir by the following formula. And when dimd_mode_flag is 0, dimd_mode_dir will be set to 0, too.

dimd_mode=((dimd_mode_flag==0)?0:1)+dimd_mode_dir

In this example, DIMD_MODE_TOP_LEFT is represented by 1 bit (such as “0”), and 1 bit is allocated after “0” to represent DIMD_MODE_TOP and DIMD_MODE_LEFT. In the binarization of dimd_mode, for DIMD_MODE_TOP_LEFT mode which with high selection rate, using a bits which is shorter than the selection of DIMD_MODE_TOP and DIMD_MODE_LEFT mode. This can shorten the average coding amount to improve the coding efficiency.

The parameter decoding unit 302 notifies the entropy decoding unit 301 of which syntax elements need be decoded. The entropy decoding unit 301 outputs the syntax element to the prediction parameter derivation unit 320.

### Configuration of Prediction Parameter Derivation Unit 320

The prediction parameter derivation unit 320 may derive the prediction parameters based on the output of the parameter decoding unit 302 and the prediction parameters which saved in the prediction parameter memory 307. The derived prediction parameters will be output into the prediction image generation unit 308 and also will be saved in the prediction parameter memory 307. The prediction parameter derivation unit 320 may derive different prediction mode for the Luma and Chroma prediction.

The loop filter 305 is a filter provided in the coding loop, and is a filter that removes block distortion and ringing distortion and improves image quality. The loop filter 305 applies a filter such as a deblocking filter, a Sample Adaptive Offset (SAO), and an Adaptive Loop Filter (ALF) on a decoded image of a CU generated by the addition unit 312.

The reference picture memory 306 stores the decoded image of the CU generated by the addition unit 312 in a predetermined position for each target picture and target CU.

The prediction parameter memory 307 stores prediction parameters in a predetermined position for each CTU or CU to be decoded. Specifically, the prediction parameter memory 307 stores a parameter derived by the prediction parameter derivation unit 320, a prediction mode predMode separated by the entropy decoding unit 301, and the like.

The prediction image generation unit 308 receives input of the prediction parameter derived by the prediction parameter deviation unit 320, and the like. In addition, the prediction image generation unit 308 reads a reference picture from the reference picture memory 306. The prediction image generation unit 308 generates a prediction image of a block or a subblock by using the prediction parameter and the read reference picture (reference picture block) in the prediction mode indicated by the prediction mode predMode. Here, the reference picture block refers to a set of pixels (referred to as a block because they are normally rectangular) on a reference picture and is a region that is referred to to generate a prediction image.

### Prediction Image Generation Unit 318

In a case that the prediction mode predMode indicates an intra prediction mode, the intra prediction image generation unit 310 performs an intra prediction by using an intra prediction parameter (luma intra prediction mode IntraPredModeY and/or chroma intra prediction mode IntraPredModeC) input from the prediction parameter derivation unit 320 and reference pixels read from the reference picture memory 306. In a case that the prediction mode predMode indicates an inter prediction mode, the inter prediction image generation unit performs an inter prediction by using an inter prediction parameter input from the prediction parameter derivation unit 320 and reference pixels read from the reference picture memory 306.

Specifically, the prediction image generation unit 308 reads, from the reference picture memory 306, a neighbouring block in a predetermined range from a target block on a target picture. The predetermined range is neighbouring blocks on the left, the top left, the top, and the top right of the target block, and the region referred to is different depending on the intra prediction mode.

The prediction image generation unit 308 generates a prediction image of the target block with reference to the read decoded pixel values and the prediction mode indicated by predMode, IntraPredModeY and/or IntraPredModeC. The prediction image generation unit 308 outputs the generated prediction image of the block to the addition unit 312.

The generation of the prediction image based on the intra prediction mode will be described below. In the Planar prediction, the DC prediction, and the Angular prediction, a decoded peripheral region adjacent to (proximate to) the prediction target block is configured as a reference region R. Then, the pixels on the reference region R are extrapolated in a specific direction to generate the prediction image. For example, the reference region R may be configured as an L-shaped region including the left and top (or further, top left, top right, bottom left) of the prediction target block.

### Intra Prediction Image Generation Unit 310

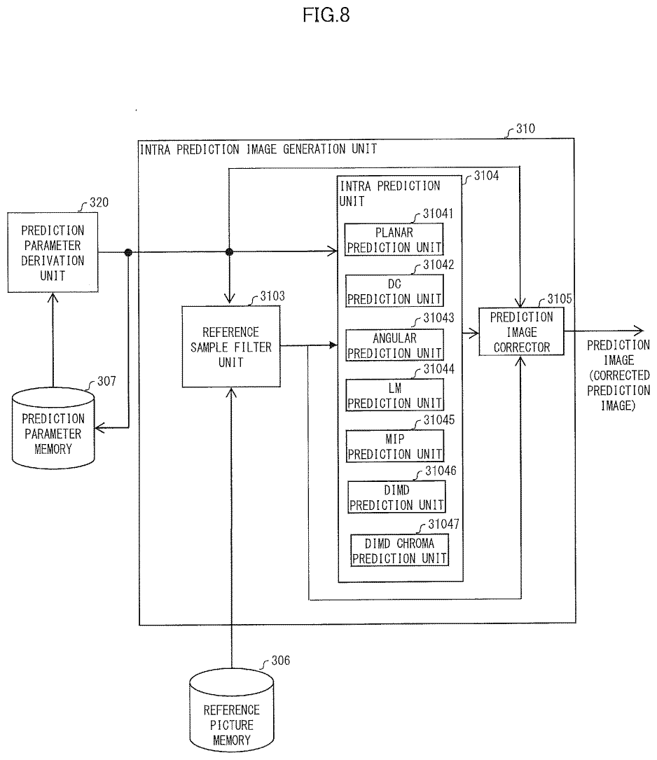

A configuration of the intra prediction image generation unit 310 will be described using FIG. 8. The intra prediction image generation unit 310 includes a reference sample filter unit 3103 (second reference image configuration unit), an intra prediction unit 3104), and a prediction image corrector 3105 (prediction image corrector, filter switching unit, weight coefficient changing unit).

Based on each reference pixel (unfiltered reference image) on the reference region R, a filtered reference image generated by applying a reference pixel filter (first filter), and the intra prediction mode, the intra prediction unit 3104 generates a prediction image of the target block, and outputs the generated image to the prediction image corrector 3105. The prediction image corrector 3105 corrects the prediction image in accordance with the intra prediction mode, and outputs a corrected prediction image.

Hereinafter, the units included in the intra prediction image generation unit 310 will be described.

### Reference Sample Filter Unit 3103

The reference sample filter unit 3103 applies the reference pixel filter (first filter) to the unfiltered reference image to derive a filtered reference image s[x][y] at each position (x,y) on the reference region R, in accordance with the intra prediction mode. Specifically, a low pass filter is applied to the unfiltered reference image at each position (x,y) and its surroundings, and a filtered reference image is derived. Note that the low pass filter need not necessarily be applied in all the intra prediction modes, and the low pass filter may be applied in some intra prediction modes. Note that the filter applied to an unfiltered reference image on a reference region R in the reference sample filter unit 3103 is referred to as the “reference pixel filter (first filter)”, whereas a filter that corrects the prediction image in the prediction image corrector 3105 described below is referred to as a “boundary filter (second filter)”.

### Configuration of Intra Prediction Unit 3104

The intra prediction unit 3104 generates, based on the intra prediction mode, the unfiltered reference image, and the filtered reference pixel value, a prediction image (prediction pixel value, uncorrected prediction image) of the prediction target block, and outputs a generated image to the prediction image corrector 3105. The intra prediction unit 3104 includes a Planar prediction unit 31041, a DC prediction unit 31042, an Angular prediction unit 31043, an LM prediction unit 31044, an MIP prediction unit (Matrix-based Intra Prediction) 31045, a DIMD (Decoder-side Intra Mode Derivation, DIMD) prediction unit 31046, and a DIMD CHROMA prediction unit 31047 in the inside thereof. The intra prediction unit 3104 selects a specific predictor in accordance with the intra prediction mode, and inputs an unfiltered reference image and a filtered reference image thereto. The relationship between the intra prediction mode and the corresponding predictor is as follows.
Planar prediction . . . Planar prediction unit 31041
DC prediction . . . DC prediction unit 31042
Angular prediction . . . Angular prediction unit 31043
LM prediction . . . LM prediction unit 31044
MIP prediction . . . MIP prediction unit 31045
DIMD prediction . . . DIMD prediction unit 31046
DIMD CHROMA prediction . . . DIMD CHROMA prediction unit 31047

### Planar Prediction

The Planar prediction unit 31041 generates a prediction image q[x][y] by linearly adding multiple filtered reference images s[x][y] in accordance with the distance between the prediction pixel position and the reference pixel position, and outputs the generated image to the prediction image corrector 3105.

### DC Prediction

The DC prediction unit 31042 derives a DC prediction value corresponding to the average value of the filtered reference image s[x][y], and outputs a prediction image q[x][y], which takes the DC prediction value as a pixel value.

### Angular Prediction

The Angular prediction unit 31043 generates a prediction image q[x][y] using the filtered reference image s[x][y] in a prediction direction (reference direction) indicated by the intra prediction mode, and outputs the generated image to the prediction image corrector 3105.

### LM Prediction

The LM prediction unit 31044 predicts the pixel value of the chroma based on the pixel value of luma. More specifically, a linear model is used to generate a prediction chroma image (Cb, Cr) based on the decoded luma image. As an example of LM prediction, there is a CCLM (cross component linear model prediction) prediction. CCLM prediction is a prediction method using a linear model to predict chroma from luma to same block.

### MIP Prediction

The MIP prediction unit 31045 generates a prediction image q[x][y] by the product sum operation on the reference sample s[x][y] and the weight matrix derived from the neighboring region, and outputs the prediction image q[x][y] to the prediction image corrector 3105.

### DIMD Prediction

The DIMD prediction unit 31046 generates a luma prediction image using an intra prediction mode for the target block. An intra prediction mode suitable for the target block is derived using the information of the adjacent regions, and the DIMD prediction unit 31046 generates a prediction luma image using the derived intra prediction mode. Details will be described later.

### DIMD CHROMA Prediction

The DIMD CHROMA prediction unit 31047 generates a chroma prediction image using an intra prediction mode for the target block. An intra prediction mode suitable for the target block is derived using the information of the adjacent regions, and the DIMD CHROMA prediction unit 31047 generates a chroma prediction image using the derived intra prediction mode. Details will be described later.

### Configuration of Prediction Image Corrector 3105

The prediction image corrector 3105 corrects the prediction image output from the intra prediction unit 3104 in accordance with the intra prediction mode. Specifically, the prediction image corrector 3105 derives, by performing weighted addition (weighted-averaging) on the unfiltered reference image and the prediction image for each pixel of the prediction image, in accordance with the distance between the reference region R and the target prediction pixel, the prediction image (corrected prediction image) Pred in which the prediction image is modified. Note that in some intra prediction modes (for example, Planar prediction, DC prediction, or the like), the prediction image corrector 3105 may not correct the prediction image, and the output of the intra prediction unit 3104 may be used as the prediction image.

### APPLICATION EXAMPLES

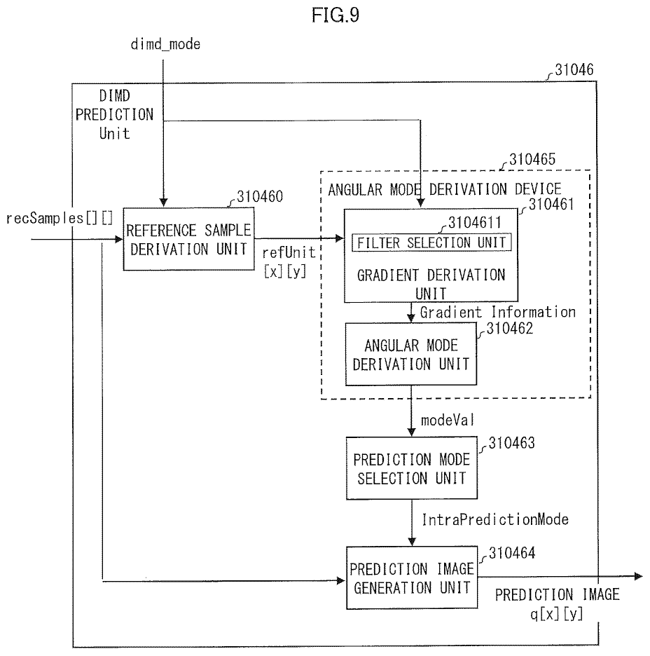

FIG. 9 shows the configuration of the DIMD prediction unit 31046 in this embodiment. The DIMD prediction unit 31046 comprises a reference sample derivation unit 310460, an angular mode derivation devices 310465, a prediction mode selection unit 310463 and a prediction image generation unit 310464. The angular mode derivation device 310465 includes a gradient derivation unit 310461 and an angular mode derivation unit 310462. The gradient derivation unit 310461 includes the filter selection unit 3104611. The angular mode derivation device 310465 may include the prediction mode selection unit 310463.

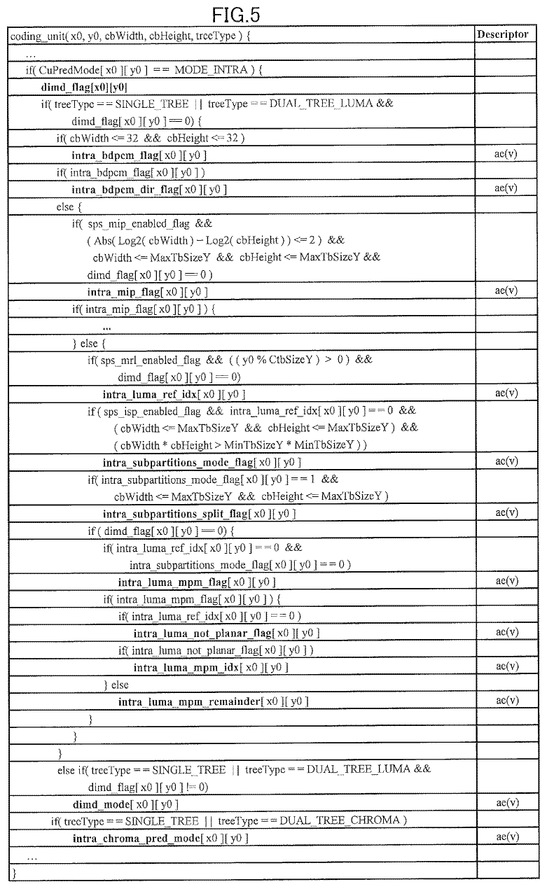

FIG. 5 shows an example of coding data about DIMD method. For each target block, the prediction parameter derivation unit 320 decodes a flag named dimd_flag used for indicating if this target block uses DIMD method. When the dimd_flag is 1, some syntax elements related to intra prediction (intra_mip_flag, intra_luma_mpm_flag, intra_luma_mpm_idx, intra_luma_mpm_reminder) are not decoded by the parameter decoding unit 302. The intra_mip_flag indicates whether MIP prediction is used or not. The intra_luma_mpm_flag is a flag for indicating if Most Probable Mode (MPM) is used. The intra_luma_mpm_idx is an index for indicating a MPM candidate when MPM is used. The intra_luma_mpm_reminder is an index for selecting a intra prediction mode from the remaining modes when MPM is not used. If dimd_flag is 0, intra_luma_mpm_flag is decoded, and if intra_luma_mpm_flag is 0 then intra_luma_mpm_reminder is decoded. When the dimd_flag of the target block is 1, then dimd_mode flag of the target block is decoded. The dimd_mode flag is a flag for indicating the reference region used for deriving intra prediction mode. The dimd_mode flag can be set following value.
dimd_mode=0 DIMD_MODE_TOP_LEFT (using top neighbouring reference region and left neighbouring reference region)
dimd_mode=1 DIMD_MODE_LEFT (using left neighbouring reference region)
dimd_mode=2 DIMD_MODE_TOP (using top neighbouring reference region)

When dimd_flag is 1, the DIMD prediction unit 31046 derives an angular mode indicating the texture direction in the neighboring region by pixel value. This angular mode will be used to generate an intra prediction image. In more detail, (step 1) deriving pixel gradient using the pixel values in a given position, (step 2) converting the derived pixel gradient to an angular prediction mode, (step 3) building a histogram using all the angular prediction mode obtained from step1 and step2. (step 4) One or more angular prediction modes are selected from the histogram and used to generate a prediction image. FIG. 9 shows the DIMD prediction unit 31046, each part of the DIMD prediction unit 31046 and the processing of each part are described in more detail in the following.

A process of the DIMD prediction unit 31046 is as follows:
Step1: Deriving pixel gradient using the pixel values in a given position.
Step2: Converting the derived pixel gradient to an angular prediction mode.
Step3: Building a histogram using all the angular prediction mode obtained from step1 and step2.
Step4: One or more angular prediction modes are selected from the histogram and used to generate a prediction image.

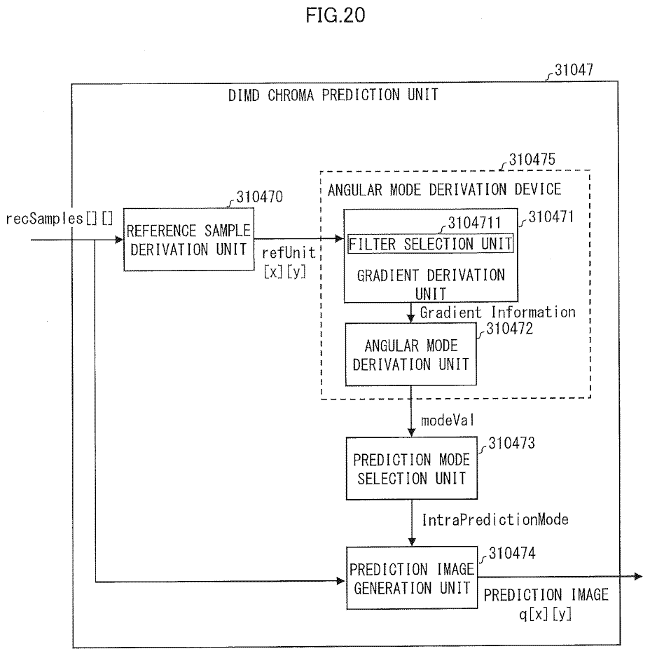

FIG. 20 shows the configuration of the DIMD CHROMA prediction unit 31047 in this embodiment. The structure of the DIMD CHROMA prediction unit 31047 is the same as the DIMD prediction unit 31046. The differences between DIMD CHROMA and DIMD methods will be described later.

DIMD CHROMA prediction unit 31047 applies the same process to chroma components of the target block.

### Reference Sample Derivation Unit

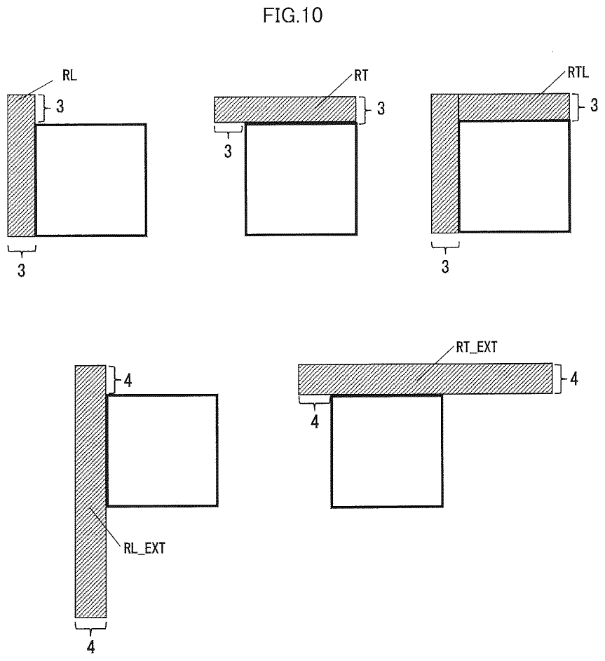

A reference sample derivation unit 310460 derives a reference sample refUnit from the previously decoded pixel recSamples adjacent to the target block. Note that, the reference sample derivation unit 310460 may included in the reference sample filter unit 3103. FIG. 10 shows an example of the reference region of the DIMD prediction unit 31046. The reference sample derivation unit 310460 stores recSamples which are adjacent to target block into a reference sample refUnit and the refUnit is used by the gradient derivation unit 310461 and the prediction image generation unit 310.

Example of deriving reference region selection based on dimd_mode If dimd_mode==DIMD_MODE_TOP_LEFT, the reference sample derivation unit 310460 derives the reference sample refUnit from the left and top regions of the target block as follows.

First, the following process is performed at a position (x,y) in which located on the left area of the target block (the left area is referred to as RL in the following).

refUnit[x][y]=recSamples[xC+x][yC+y]

Here, RL has the range of (x=−1−refIdxW . . . −1, y=0 . . . refH−1). (xC, yC) is the top-left coordinate of the target block, and refIdxW is a constant indicating the width of the reference region on the left of target block. The refIdxW may be 2, and the refH is equal to the height of target block (i.e. bH).

Second, the following process is performed in the RT, RT means the top area of target block.

refUnit[x][y]=recSamples[xC+x][yC+y]

Here, RT has the range of (x=0 . . . refW−1, y=−1−refIdxH . . . −1). The refIdxH is a constant indicating the height of the reference region on the top of target block. The refIdxH may be 2, and the refW is equal to the width of target block (i.e. bW).

Third, the following process is performed to derive reference samples in the top-left area of target block.

refUnit[x][y]=recSamples[xC+x][yC+y]

Here, x=−1−refIdxW . . . −1, y=−1−refIdxH . . . −1. (x and y can not equal to −1 in same time)
RTL is an area in which all the three areas above-mentioned are included.

If dimd_mode==DIMD_MODE_LEFT, the reference sample derivation unit 310460 derives the left and left-bottom neighboring regions of the target block.

refUnit[x][y]=recSamples[xC+x][yC+y]

Here, x=−1−refIdxW . . . −1, y=−1−refIdxH . . . refH*2−1.

In this case, the refIdxW and refIdxH are constants indicating the width and height of the reference region on the left of target block, respectively. The refIdxW and refIdxH may be equal to 3, and the refH is equal to the height of target block (i.e. bH).

If dimd_mode==DIMD_MODE_TOP, the reference sample derivation unit 310460 derives the top and top-right neighboring region of the target block.

refUnit[x][y]=recSamples[xC+x][yC+y]

Here, x=−1−refIdxW . . . refW*2−1, y=−1−refIdxH . . . −1.

In this case, the refIdxW and refIdxH are constants indicating the width and height of the reference region on the top of target block, respectively. The refIdxW and refIdxH may be equal to 3, and the refW is equal to the width of target block (i.e. bW).

It can also be written as follows.

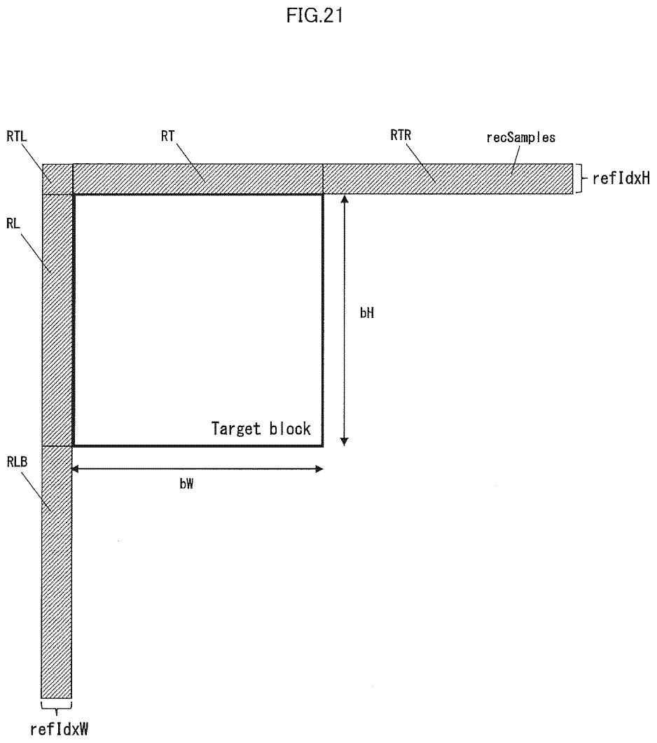

There are plural (e.g. five) reference areas: left, top, top-left, top-right, and left-bottom areas of the target block in FIG. 21. If dimd_flag==1, the reference sample derivation unit 310460 derives these plural neighboring regions of the target block as following.

First, the reference sample derivation unit 310460 derives the left and left-bottom neighboring regions of the target block. The following process is performed at a position (x,y) in which located on the left area of the target block (in the following, the left area is referred to as RL (region of left), the left-bottom area is referred to as RLB (region of left-bottom)).

refUnit[x][y]=recSamples[xC+x][yC+y]

Here, x=−refIdxW . . . −1, y=0 . . . refH*2−1. (xC, yC) is the top left coordinate of the target block.

In this case, the refIdxW and refH are constants indicating the width and height of the reference region on the left of target block, respectively. The refIdxW may be equal to 3, and the refH is equal to the height of target block (i.e. bH).

Second, the reference sample derivation unit 310460 derives the top and top-right neighboring regions of the target block. The following process is performed in the RT and RTR. RT (region of top) means the top area of target block, and RTR (region of top-right) means the top-right area of target block.

refUnit[x][y]=recSamples[xC+x][yC+y]

Here, x=0 . . . refW*2−1, y=−refIdxH . . . −1. (xC, yC) is the top left coordinate of the target block.

In this case, the refW and refIdxH are constants indicating the width and height of the reference region on the top of target block, respectively. The refIdxH may be equal to 3, and the refW is equal to the width of target block (i.e. bW).

Third, the following process is performed to derive reference samples in the top-left area of target block.

refUnit[x][y]=recSamples[xC+x][yC+y]

Here, x=−refIdxW . . . −1, y=−refIdxH . . . −1. (x and y can not equal to −1 in same time) (xC, yC) is the top left coordinate of the target block.

RTL (region of top-left) is an area in which all the three areas above-mentioned are included. The refIdxH and refIdxW may be equal to 3.

The above reference region which includes RT, RL, RTL, RTR, and RLB with refIdxH=3 and refIdxW=3 is called normal reference area. In addition to the above reference region selection method, the reference region selection method may be set in following two ways. The first is to decrease the range of reference area and select only RT, RL, and RTL as the reference area (small reference area). The second is to increase the range of reference area, select RT, RL, RTL, RTR, and RLB as the reference area, and increasing the value of refIdxH and refIdxW, for example 4 (large reference area).

In this embodiment, the reference sample derivation unit 310460 may use different reference regions described above, i.e. small reference region, normal reference region, and large reference region. The reference sample derivation unit 310460 may use regionType value for them as regionType=0, 1 and 2 for small, normal and large reference regions.

The reference area selection according to the size of the target block Specifically, the reference sample derivation unit 310460 derives a blockType value by comparing one or more threshold values and the size of the target block. If the width and height of the target block are less than or equal to the respective thresholds (bW<=THW0 && bH<=THH0), the target block is a small block (blockType=0); Otherwise, if the width and height of the target block are less than or equal to another respective thresholds (bW<=THW1 && bH<=THH1), the target block is a normal block (blockType=1); Otherwise, i.e. the width and height of the target block is greater than the another respective thresholds (bW>THW1∥bH>THH1), the target block is a large block (blockType=2). THW0 and THH0 may be 16 and THW1 and THH1 may be 64. It is noted that the thresholds are not only limited to the ones described above, but also may be set in other ways. THW0 and THH0 may not be the same value and THW1 and THH1 may not be the same value. For example, THW0 may be 8 and THH0 may be 16.

The reference sample derivation unit 310460 may derive reference region area depending on the target block's size and/or shape. The reference region area may be a small reference area, a normal reference area, or a large reference area, which may be distinguished by a region type value (regionType). In an embodiment, the reference sample derivation unit 310460 derives a large reference area (regionType=2) for large target blocks (blockType is 2), a normal reference area (regionType=1) for normal target blocks (blockType is 1), and a small reference area (regionType=0) for small target blocks (blockType is 0). In an another embodiment, the reference sample derivation unit 310460 uses a small reference area for a large target block, uses a normal reference area for a normal target block, and uses a large reference area for a small target block. Alternatively, the reference sample derivation unit 310460 uses the same reference area regardless of the size of the target area. The selection of reference area is not only limited to the above examples, but also has other ways. As region is selected (regionType is derived), the gradient derivation unit 310461 derives directions using the selected reference area. It is noted that without introducing intermediate values (i.e. regionType and blockType), a reference area may be directly selected depending on target block width and height.

### Gradient Derivation Unit

The gradient derivation unit 310461 derives gradient values in two or more specific directions (for example, Dx and Dy) based on pixel values of the neighboring blocks of the target block and corresponding spatial filters (for example, a filter for Dx and another filter for Dy), and derives angle information that represents a direction of texture patterns from the gradient values (Dx and Dy). The accuracy of angle information may be set in other ways, for example, it may be set to approximately 1/36 degree units.

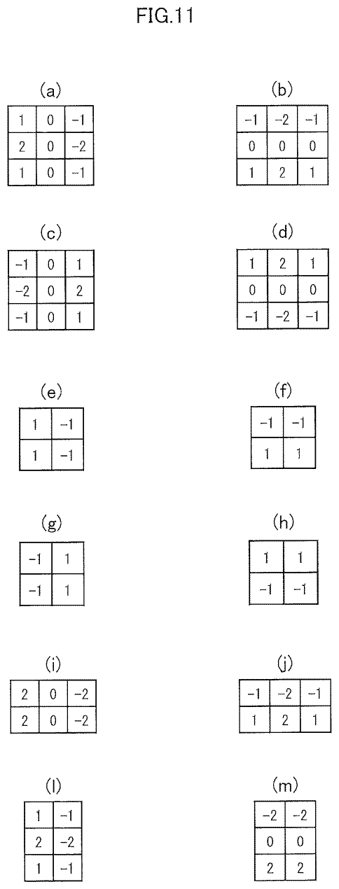

Spatial filters are used for deriving the gradient. The spatial filter may be a 3×3 pixel filter or a 2×2 pixel filter corresponding to the horizontal and vertical directions, as shown in FIG. 11 (a, b, e, f). The gradient derivation unit 310461 derives gradient values for a point P[x][y](hereinafter simply referred to as P) in the reference sample refUnit[x][y] derived by the reference sample derivation unit 310460. It is possible to use the point recSamples[xC+x][yC+y] instead of the point refUnit[x][y] as point P.

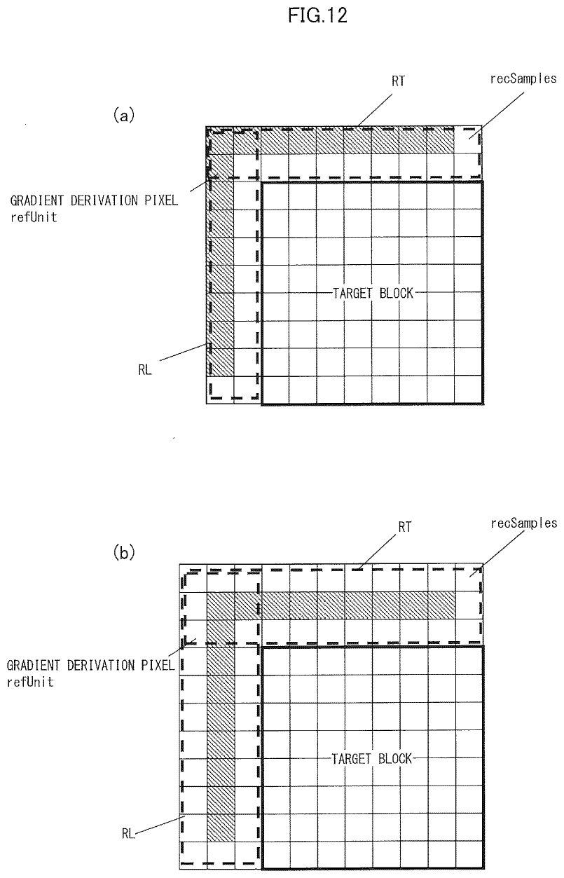

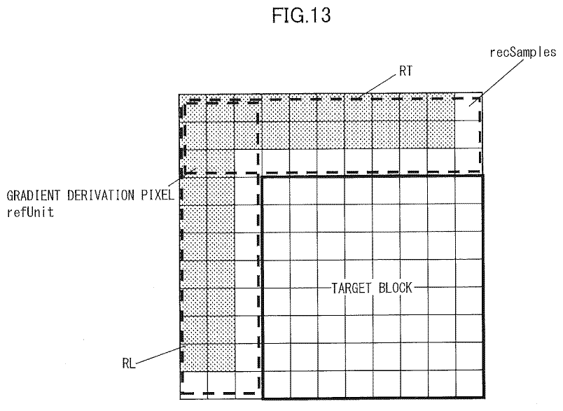

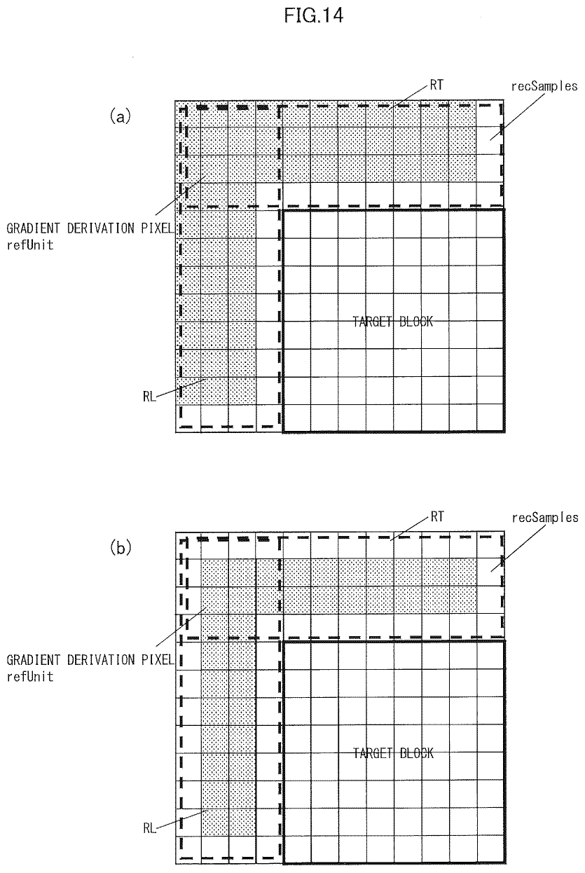

FIG. 12 and FIG. 13 show examples of gradient target image in a target block of 8×8 pixels for 2×2 and 3×3 filters respectively. The pixels in the gradient target image are used to calculate gradient. When the angular mode derivation unit 310462 is used for intra prediction, the meshed image in neighboring region of the target block is the gradient target image of target block (shown in FIG. 12 and FIG. 13). The gradient target image is the luma image of the target block. The number of the pixels used for the gradient deriviation to select an angular mode (modeVal) can be changed depending on the size of the target block (bW, bH). The number of the pixels used for the gradient deriviation is determined by spatial filter. Thus the number of taps of the spatial filter (spatial filter size) can be changed depending on the size of the target block. The minimum number of rows of reference area required varies depending on the size of the filter. For example, a 2×2 filter requires a minimum of 2 rows, while a 3×3 filter requires a minimum of 3 rows. The number of reference rows obtained from the current block's neighborhood must be greater than or equal to the minimum reference rows required by the selected filter. For rectangular filters like 3×2 and 2×3, the minimum required reference rows for horizontal and vertical directions are different. The specific number of reference rows can be determined based on the filter. In this case, the reference row count is defined as the minimum reference rows required by the filter, as shown in FIG. 12 (a), (b). Alternatively, the number of reference rows can be defined based on DIMD modes. For example, when using DIMD_MODE_TOP_LEFT mode, the row count can be set to “n” (where n==3). FIG. 13 illustrates the region of influence for a 2×2 filter when the reference row count is set to 3. However, when DIMD is in DIMD_MODE_TOP or DIMD_MODE_LEFT mode, the reference row count is set to “n+1” (4). FIG. 14(a), (b) show the regions of influence for 2×2 and 3×3 filters when the reference row count is set to 4. The value of “n” can be set in various ways (not only equal to 3), and there are multiple ways to configure the reference row count for DIMD_MODE_TOP_LEFT, DIMD_MODE_TOP, and DIMD_MODE_LEFT modes.

The filter selection unit 3104611 determines the size of the filter (derives a parameter filterIdx) based on the size of the target block (bW, bH). A variable filterIdx is defined to indicate the currently selected filter. The value of filterIdx is obtained from the following equation.

filterIdx=(bW<=TW1 && bH<=TH1)?0:1
where TW1=16, TH1=16.

In other words, the filter selection unit 3104611 determines the size of the filter (e.g. whether to use a 2×2 filter or a 3×3 filter) according to the size of the target block. For the small target blocks whose width and height are equal to or less than 16, the smaller 2×2 filter is used, and for the not small (larger) target blocks with other sizes, the larger 3×3 filter is used.

The gradient derivation unit 310461 derive the gradient Dx and Dy in the horizontal and vertical directions respectively for each point P based on filterIdx as the following formulas. Thus the gradient derivation unit 310461 derives Dx and Dy depending on the size of the target block in which larger filter is used for larger blocks.

If filterIdx==0 (for small target blocks), 2×2 filter is applied as follows

Dx=P[x][y]+P[x][y+1]−P[x+1][y]−P[x+1][y+1]

Dy=P[x][y]+P[x+1][y]−P[x][y+1]−P[x+1][y+1]

If filterIdx==1 (for other blocks), 3×3 filter is applied as follows

Dx=P[x−1][y+1]+2*P[x][y+1]+P[x+1][y+1]−P[x−1][y−1]−2*P[x][y−1]−P[x+1][y−1]

Dy=P[x−1][y−1]+2*P[x−1][y]+P[x−1][y+1]−P[x+1][y−1]−2*P[x+1][y]−P[x+1][y+1]

It is noted a 2×2 filter may use four positions of (x,y), (x+1, y), (x, y+1), (x+1,y+1) whereas a 3×3 filter may use nine positions of (x−1, y−1), (x, y−1), (x+1, y−1), (x−1, y), (x,y), (x+1, y), (x−1, y+1), (x, y+1), (x+1,y+1). 4×4 filter may use 16 positions of (x−1, y−1), (x, y−1), (x+1, y−1), (x+2, y−1), (x−1, y), (x,y), (x+1, y), (x+2, y), (x−1, y+1), (x, y+1), (x+1,y+1), (x+2,y+1), (x−1, y+2), (x, y+2), (x+1,y+2), (x+2,y+2). Similar 2×3 filter and 3×2 filter may use 6 positions (x, y−1), (x+1, y−1), (x,y), (x+1, y), (x, y+1), (x+1,y+1) and (x−1, y), (x,y), (x+1, y), (x−1, y+1), (x, y+1), (x+1,y+1) respectively. In general M×N filter may use (x+xx, y+yy), xx=−(M−1)/2 . . . M/2, yy=−(N−1)/2 . . . N/2. where / means integer division with truncation of the result toward zero.

The signs of each component of the above equations can be reversed, i.e. the filters of FIG. 11(a,b,e,f) can be rotated by 180 degrees and become the filters of FIG. 11(c,d,g,h), which is can be used for deriving gradient. In this case, Dx and Dy are derived using the following equations.

If filterIdx==0 (for small target blocks), 2×2 filter is applied as follows

Dx=P[x+1][y]+P[x+1][y+1]−P[x][y]−P[x][y+1]

Dy=P[x][y+1]+P[x+1][y+1]−P[x][y]−P[x+1][y]

If filterIdx==1 (for other blocks), 3×3 filter is applied as follows

Dx=P[x−1][y−1]+2*P[x][y−1]+P[x+1][y−1]−P[x−1][y+1]−2*P[x][y+1]−P[x+1][y+1]

Dy=P[x+1][y−1]+2*P[x+1][y]+P[x+1][y+1]−P[x−1][y−1]−2*P[x−1][y]−P[x−1][y+1]

The gradient derivation method is not only limited to the above but also can be configured in other ways.

### Examples of Other Threshold

Thresholds (TW1, TH1) may be set equal to (32, 32), (16,32), (32, 16) and so on. “<=” can be replaced with “<” as followings

filterIdx=(bW<TW1&& bH<TH1)?0:1

The target block size determination can be conducted based on bW+bH.

filterIdx=(bW+bH<=TWH1)?0:1

Threshold TWH1 may be set equal to 16, 32, 64 and so on.

The target block size determination can be conducted based on bW*bH.

filterIdx=(bW*bH<=TWH2)?0:1

Threshold TWH2 may be set equal to 256, 512, 1024 and so on.

The target block size determination can be conducted based on log 2(bW)+log 2(bH).

filterIdx=(log 2(bW)+log 2(bH)<=TWH3)?0:1

Threshold TWH3 may be equal to 8, 9, 10 and so on.

It is note that the thresholds are not limited to the above values.

### 3 Filters

The filter selection unit 3104611 may use two thresholds to select a filter from three types according to the size of target blocks: large, medium and small. The filter selection unit 3104611 selects 4×4, 3×3 and 2×2 filters for large, medium and small target blocks, respectively. The filter size can be set as follows.

filterIdx=(bW<TW1&& bH<TH1)?0:(bW<TW2&& bH<TH2)?1:2
where TW1, TH1, TW2, TH2 can be 16, 16, 32, 32

### Rectangular Filter

In addition to the square filter, rectangular (non square) filters can be used. FIG. 11(i,j,m,l) shows an example of two groups of rectangular filters. Taking the filter shown in FIG. 11(i,j) as an example. It is a rectangular filter (3×2 filter) with a width of 3 and a height of 2. The corresponding Dx and Dy can be calculated according to the following formula.

Dx=P[x−1][y+1]+2*P[x][y+1]+P[x+1][y+1]−P[x−1][y]−2*P[x][y]−P[x+1][y]

Dy=2*P[x−1][y]+2*P[x−1][y+1]−2*P[x+1][y−1]−2*P[x+1][y+1]

Similarly, the gradient derivation formula of the filter (2×3 filter) shown in FIG. 11(m,l) is as follows.

Dx=2*P[x][y−1]+2*P[x+1][y−1]−2*P[x][y+1]−2*P[x+1][y+1]

Dy=P[x][y−1]+2*P[x][y]+P[x][y+1]−P[x+1][y−1]−2*P[x+1][y]−P[x+1][y+1]

Rectangular filters are not only limited to the above two types, but also can have other kinds.

Depending of the block size, The filter selection unit 3104611 determines the size of the filter based on the size of the target block (bW, bH).

filterIdx=(bW<=8&& bH<=8)?0:((bW<=16&& bH<=16)?(bW>bH?3:4):1)

The gradient derivation unit 310461 derives Dx and Dy depending on the derived filterIdx.

If filterIdx==0 (for small target blocks, e.g. bW<=8 && bH<=8), 2×2 filter is applied.

Dx=P[x][y]+P[x][y+1]−P[x+1][y]−P[x+1][y+1]

Dy=P[x][y]+P[x+1][y]−P[x][y+1]−P[x+1][y+1]

Otherwise, if filterIdx==3 (for horizontally longer rectangular block, bW>bH && bW<=16 && bH<=16), 3×2 filter is applied.

Dx=P[x−1][y+1]+2*P[x][y+1]+P[x+1][y+1]−P[x−1][y]−2*P[x][y]−P[x+1][y]

Dy=2*P[x−1][y]+2*P[x−1][y+1]−2*P[x+1][y−1]−2*P[x+1][y+1]

Otherwise, if filterIdx==4 (for vertically longer rectangular block, bW<bH && bW<=16 && bH<=16), 2×3 filter is applied.

Dx=2*P[x][y−1]+2*P[x+1][y−1]−2*P[x][y+1]−2*P[x+1][y+1]

Dy=P[x][y−1]+2*P[x][y]+P[x][y+1]−P[x+1][y−1]−2*P[x+1][y]−P[x+1][y+1]

Otherwise, if filterIdx==1 (other blocks), 3×3 filter is applied.

Dx=P[x−1][y+1]+2*P[x][y+1]+P[x+1][y+1]−P[x−1][y−1]−2*P[x][y−1]−P[x+1][y−1]

Dy=P[x−1][y−1]+2*P[x−1][y]+P[x−1][y+1]−P[x+1][y−1]−2*P[x+1][y]−P[x+1][y+1]

The filter selection unit 3104611 may determines the size of the filter based on dimd_mode. If both of top and left neighbouring blocks are referred, larger filter (e.g. 3×3) is used otherwise smaller filter (e.g. 2×2) is used.

filterIdx=(dimd_mode!=DIMD_MODE_TOP_LEFT)?0:1

The gradient derivation unit 310461 derives Dx and Dy depending on the derived filterIdx.

For complexity rediction, the filter selection unit 3104611 may determine the size of the filter based on dimd_mode, in other way to use smaller blocks in case of more reference image (e.g. DIMD_MODE_TOP_LEFT). If both of top and left neighbouring blocks is referred, larger filter (e.g. 2×2) is used otherwise smaller filter (e.g. 3×3) is used.

filterIdx=(dimd_mode==DIMD_MODE_TOP_LEFT)?0:1

The gradient derivation unit 310461 derives Dx and Dy depending on the derived filterIdx.

The filter selection unit 3104611 may determines the size of the filter including rectangular kernels (e.g. 3×2, 2×3) based on dimd_mode. If both of top and left neighbouring blocks are referred, larger filter (e.g. 2×2) is used, otherwise smaller filter (e.g. 3×2) is used for DIMD_MODE_LEFT and another smaller filter (e.g. 2×3) is used for DIMD_MODE_TOP.

filterIdx=(dimd_mode==DIMD_MODE_TOP_LEFT)?0:(dimd_mode DIMD_MODE_LEFT)?3:4.

### Additional Spatial Filters

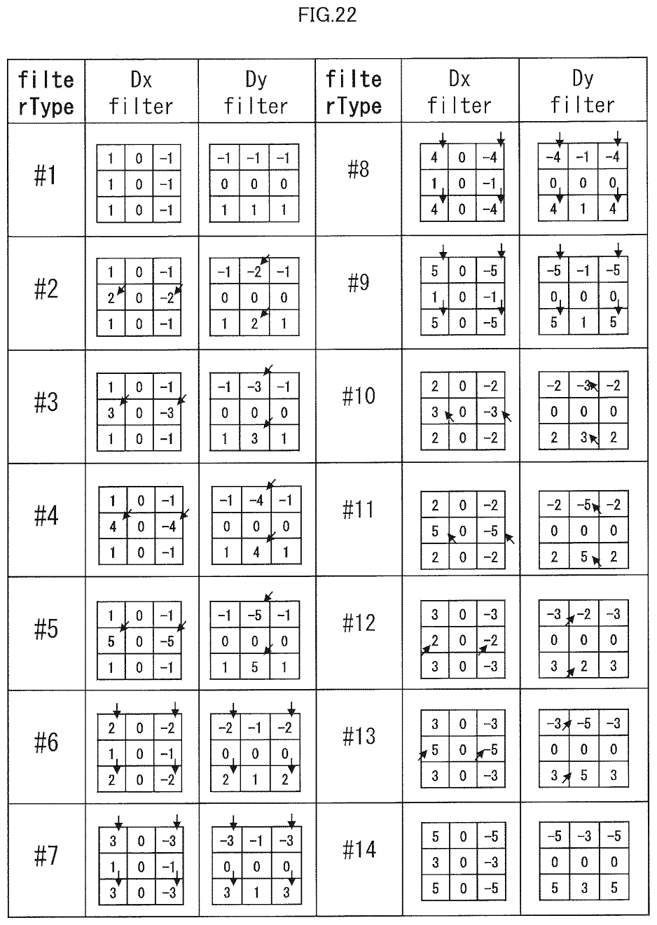

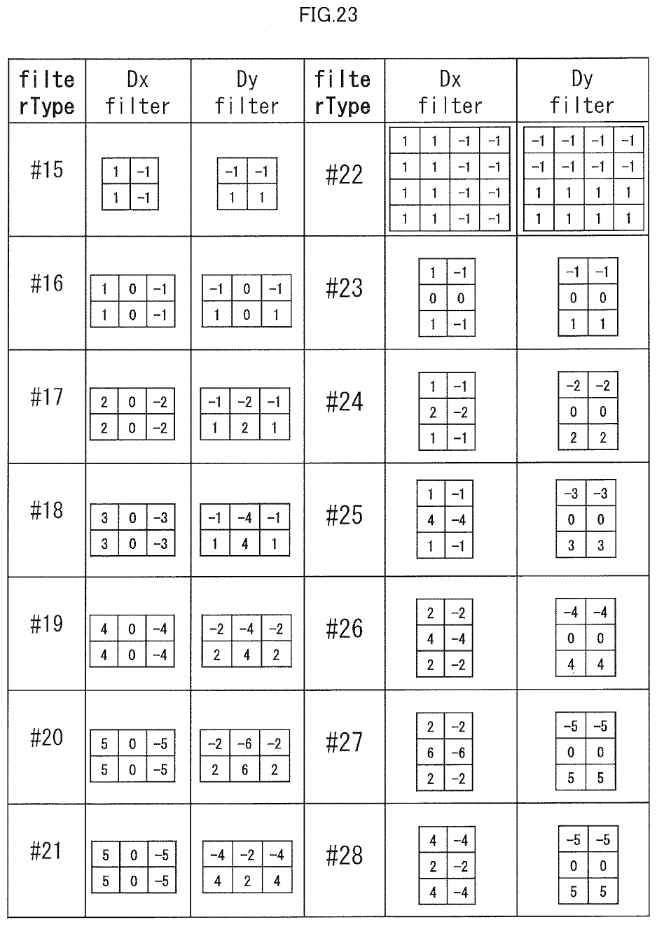

FIG. 22 and FIG. 23 show examples of spatial filters. FIG. 22 shows 14 pairs of 3×3 filters. Each pair contains two filters, namely Dx filter and Dy filter corresponding to the horizontal and vertical gradients Dx and Dy. Each pair is given a number (filterType=#1 . . . #14) or filterType. FIG. 23 shows 14 pairs (filterType=#15 . . . #28) of include 2×2, 3×2, 4×4, and 2×3 filters. Note that the weights of filters are not limited to these examples and the other filterType value may be used (assigned). A variable named “filterIdx” may be used to indicate the selected filter. The range of filterIdx values is determined by the number of candidate filters. If the gradient derivation unit 310461 uses N set of filters, filterIdx may be 0 . . . N−1. For example, in the case of selecting a filter based on the size of the target block, there may be three candidate filters with filterType #3, #2, and #1. In this case, filterIdx may be defined such that filterIdx==0 means filterType #3, filterIdx==1 means filterType #2, and filterIdx==2 means filterType #1.

The gradient derivation unit 310461 derives gradient values for a point P[x][y](hereinafter simply referred to as P) in the reference sample refUnit derived by the reference sample derivation unit 310460. It is possible to use the point recSamples [xC+x][yC+y] instead of the point refUnit[x][y] as point P. (xC, yC) is the top left coordinate of the target block. The gradient derivation unit 310461 derive gradients of a target block using pixels of the neighboring image using different filters depending on the target block. The gradient derivation unit 310461 may include the filter selection unit 3104611 and the filter selection unit 3104611 may change the weight of filters of a target block depending on the target block. The filter selection unit 3104611 may derive filters and the gradient derivation unit 310461 may derive gradients using the derived filters. The gradient derivation unit 310461 may directly apply the selected filter without deriving filterType value.

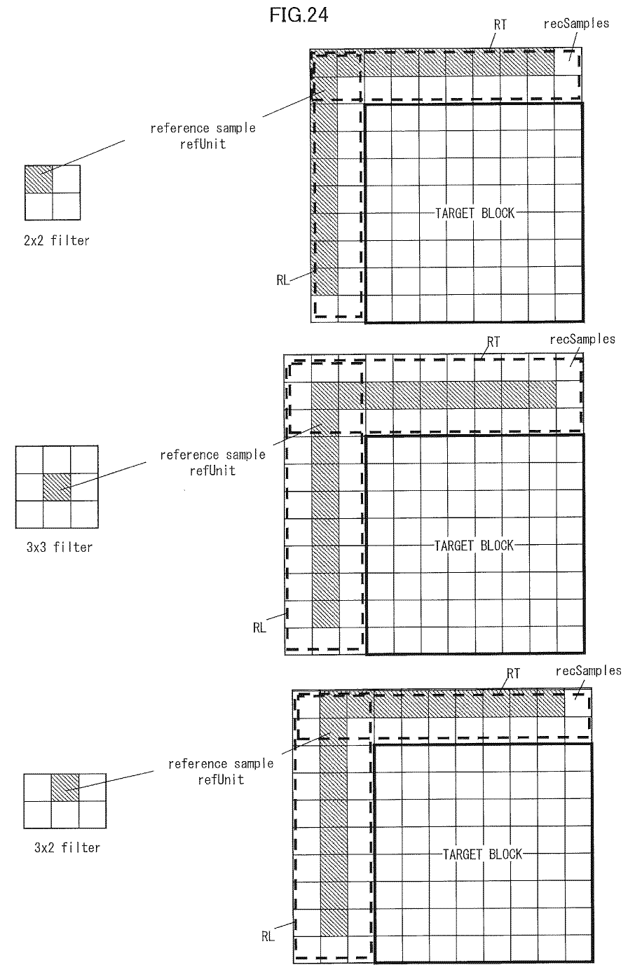

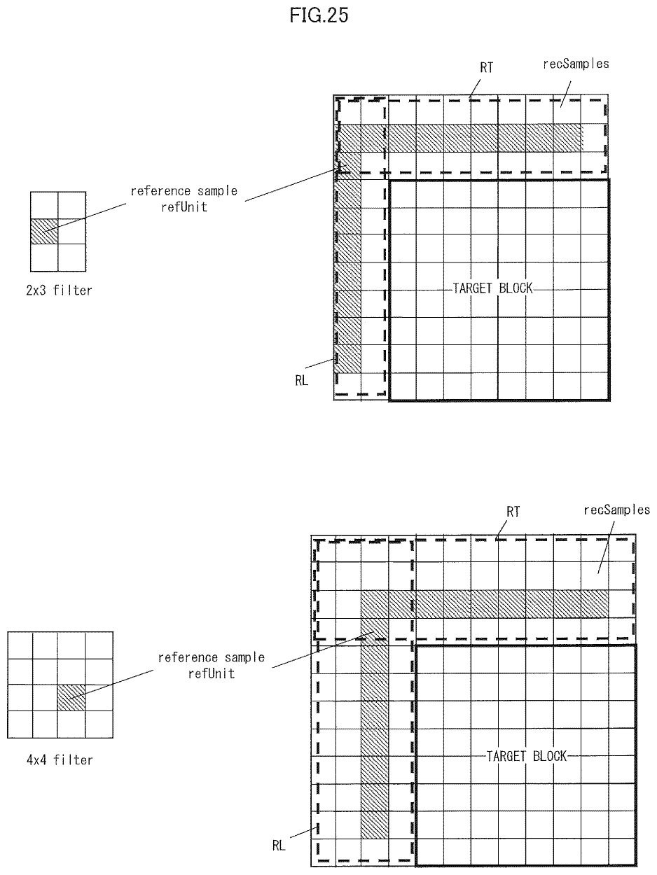

FIG. 24 and FIG. 25 show examples of gradient target image in a target block of 8×8 pixels for filters, respectively. The pixels in the gradient target image are used to calculate gradient of each gradient derivation pixel. The meshed image in neighboring region of the target block is the gradient target image of the target block. The gradient target image is a luma image. The number of the pixels used for the gradient deriviation to select an angular mode (modeVal) may be changed depending on the size of the target block (bW, bH). The number of taps of the spatial filter (spatial filter size) may be changed depending on the size of the target block.

The filter selection unit 3104611 determines the filters (a set of filters for Dx and Dy) with different weights based on the size of the target block (bW, bH). The candidate filters shown in FIG. 22 and FIG. 23 may be selected. The selection may be done according to the size of the target block, e.g. the sum of the width and height of the target block. The filter selection unit 3104611 may determine a filter with different weights as follows.

if (bW+bH<=a threshold){filterIdx=0, use a weight values at certain positions, e.g. 3}

else {filterIdx=1, use a different weight values at certain positions, e.g. 2}

The weight values of the certain positions may be central elements or side elements in which the central elements are defined as position (x, y−1), (x−1,y), (x+1,y) and (x, y+1) in the 3×3 filter as shown FIG. 22. #1, #2, #3, #4, #5 and FIG. 22. #1, #10, #11 and, FIG. 22. #1, #12, #13. The side elements are defined as position (x−1, y−1), (x+1,y−1), (x−1,y+1) and (x+1, y+1) in the 3×3 filter as shown FIG. 22. #1, #6, #7, #8, #9. Diagonal arrows indicates central elements whereas vertical arrows indicates side elements.

For example, the filter selection unit 3104611 may select a spatial filter such that the absolute weight value of central elements (a.k.a center weight) may decrease as the block size increase.

if (bW+bH<=40){filterIdx=0,select filterType #3,center weight=3}

else if (bW+bH<=64){filterIdx=1,select filterType #2,center weight=2}

else {filterIdx=2,select filterType #1,center weight=1}

For another example, the filter selection unit 3104611 may select a spatial filter such that the absolute weight value of side elements in the 3×3 filter may increase as the size of block size increase.

if (bW+bH<=128){filterIdx=2, select filterType #1, center weight=1}

else if (bW+bH<=256){filterIdx=1, select filterType #2, center weight=2}

else{filterIdx=0, select filterType #3, center weight=3}

For another example, the filter selection unit 3104611 may select a spatial filter such that the weight of the central elements in the 3×3 filter may decrease as the block size increase to the certain size and increase as the size of block size.

The filter selection unit 3104611 may determine a filter or filterType as follows.

if (bW+bH<=40){filterIdx=0, select filterType #3, center weight=3}

else if (bW+bH<=64){filterIdx=1, select filterType #2, center weight=2}

else if (bW+bH<=128){filterIdx=2, select filterType #1, center weight=1}

else if (bW+bH<=256){filterIdx=1, select filterType #2, center weight=2}

else{filterIdx=0, select filterType #3, center weight=3}

For another example, the filter selection unit 3104611 may select a spatial filter such that the weight of the side elements in the 3×3 filter may decrease as the block size increase to the certain size and increase as the size of block size.

The filter selection unit 3104611 may determine a filter or filterType such that the weight of the side elements in the 3×3 filter may decrease as the block size increase.

if (bW+bH<=40){filterIdx=0, select filterType #7, side weight=3}

else if (bW+bH<=64){filterIdx=1, select filterType #6,side weight=2}

else {filterIdx=2, select filterType #1,side weight=1}

The filter selection unit 3104611 may determine a filter or filterType such that the weight of the side elements in the 3×3 filter may decrease as the block size increase.

if (bW+bH<=40){filterIdx=0, select filterType #1,side weight=1}

else if (bW+bH<=64){filterIdx=1, select filterType #6,side weight=2}

else {filterIdx=2, select filterType #7,side weight=3}

Those thresholds and filterType may be represented using two arrays, THArray[40,64,128,256] and filterCandList[#3, #2, #1, #2, #3] and the procedure may be represented as followings.

if (bW+bH <= THArray[0]) { filterType= filterCandList[0] }
else if (bW+bH <= THArray[1]) { filterType= filterCandList[1] }
else if (bW+bH <= THArray[2]) { filterType= filterCandList[2] }
else if (bW+bH <= THArray[3]) { filterType= filterCandList[3] }
else{ filterType= filterCandList[4] }
or
for i=0..3
if bW + bH <= THArray[i], filterType is set equal to filterCandList[i]
otherwise (i==4) filterType is set equal to filterCandList[i].

It is noted that the filter selection unit 3104611 may directly use corresponding spatial filters and conditions without deriving intermediate values, i.e. THArray and filterCandList.

Different embodiments of the filter selection unit 3104611 is shown below.
1. As the size of the target block increases, the weight of the central elements in 3×3 filter increases first and then decreases. filterCandList may be [#1, #2, #3, #2, #1] or [#1, #3, #5, #3, #1].
2. As the size of the target block increases, the weight of the central elements in 3×3 filter increases. filterCandList may be [#1, #2, #3, #4, #5].
3. As the size of the target block increases, the weight of the central elements in 3×3 filter decreases. filterCandList may be [#5, #4, #3, #2, #1].
4. As the size of the target block increases, the weight of the elements on the sides in 3×3 filter decreases first and then increases. filterCandList may be [#7, #6, #1, #6, #7].
5. As the size of the target block increases, the weight of the elements on the sides in 3×3 filter increases. filterCandList may be [#1, #6, #7, #8, #9].

The threshold value in the above examples may be changed from [40,64,128,256] to [32,64,128,256] or others. The number and value of thresholds may be used.

Filter Selection Method 2 In an embodiment, the filter selection unit 3104611 selects filters (a set of filter for

Dx and Dy) with different size (the size of the filter) depending on the size of the target block. For example, for small target blocks, a 2×2 filter is selected, for medium target blocks, a 3×3 filter is selected, and for large target blocks, a 4×4 filter is selected. THArray may be [64, 128] and filterCandList may be [#15, #1, #22].

In other embodiment, the filter selection unit 3104611 selects small filters for large blocks and large filters for small blocks, THArray may be set to [#64, #128] and filterCandList may be [#22, #1, #15].

The filter selection unit 3104611 may select filter depending on the the product of the block width and block height. e.g. bW×bH, where THArray may be [1024, 4096].

The filter selection unit 3104611 may select filter depending on the sum of logarithmic block width and block height, e.g. log(bW)+log(bH) where THArray may be [#10, #12].

The filter selection unit 3104611 may selects filter depending on the product of logarithmic block width and block height. e.g. log(bW) x log(bH) where THArray may be [25, 36].

The filter selection unit 3104611 may select filter depending on block width and block height. e.g. bW<=THArray[i]&& bH<=THArray[i] where i=0, 1 and THArray may be [32, 64].

The filter selection unit 3104611 may select filter depending on logarithmic block width and logarithmic block height. e.g. log(bW)<=THArray[i]&& log(bH)<=THArray[i] where i=0, 1 and THArray may be [5, 6].

It is noted that M×M and N×N filters (M>N) may be represented with M×M filter with zero value in specific positions (e.g. 2×2 filter may be 3×3 with kind of L shape five zeros in it).

In an embodiment, the filter selection unit 3104611 selects filters (a set of filter for Dx and Dy) with different weights depending on the shape of the target block.

if (bW==bH){filterIdx=0, use a weight values at certain positions, e.g. 1}

else {filterIdx=1, use a weight values at certain positions, e.g. 2}

The filter selection unit 3104611 may select filters such that the weight of the center elements may be different depending on the block shape.

if (bW==bH){filterIdx=1, select filterType #1, center weight=1}

else {filterIdx=2, select filterType #2,side weight=2}

The filter selection unit 3104611 may select filters such that the weight of the side elements may be different depending on the block shape.

if (bW==bH){filterIdx=0, select filterType #1,side weight=1}

else {filterIdx=1, select filterType #6,side weight=2}

In another embodiment, the filter selection unit 3104611 selects filters (a set of filter for Dx and Dy) with different shape (the shape of the filter) depending on the shape of the target block.

if (bW==bH){filterIdx=0, select square filter, e.g. filterType16}

else {filterIdx=1, select non square filter, e.g. filterType #23}

For example, the 3×2 filter is used for the target block whose width is greater than the height, the 2×3 filter is used for the target block whose height is greater than the width, and the 3×3 filter is used for the target block whose height is equal to the width as follows.

if (bW > bH ) { filterIdx = 0, select 3×2 horizontal long filter, e.g. filterType16 }
else if (bW < bH ) { filterIdx = 1, select 2×3 vertical long filter, e.g. filterType#23 }
else{ filterIdx = 2, select 3×3 square filter, e.g. filterType#1 }
As summary, the filter selection unit 3104611 may select filters as follows.
if (bW > bH*K ) { filterType=filterCandList[0] or M×N horizontal long filter }
else if (bW*K < bH ) { filterType=filterCandList[2] or N×M vertical long filter }
else{ filterType=filterCandList[1] or L×L square filter, K is a constant, 1, 2, 3... }
where M,N (M>N) and L is constant (L is M or N), exampled filterCandList[ ] is {#16,
#1, #23}.

It is noted that M×N and N×N filters may be represented with L×L filter with zero value in specific positions (e.g. 3×2 filter may be 3×3 with 3×1 zero in it and 2×3 filter may be 3×3 with 1×3 zero in it).

### Derivation for Dx and Dy

The gradient derivation unit 310461 derives the gradient Dx and Dy in the horizontal and vertical directions respectively for each point P based on filter as the following formulas. Thus the gradient derivation unit 310461 derives Dx and Dy, depending on the size or the shape of the target block. The size or the shape of the target block may be used to derive the weight of the filters. As described above, a variable named “filterIdx” may be used to indicate the selected filter being used. For example, in the case of selecting the filter based on the shape of the target block, there are three candidate filters with filterType #16, #1, and #23 with filterCandList[ ] being [#16, #1, #23]. In this case, filterIdx may be defined such that filterIdx==0, 1 and 2 means filterType #16, filterType #1, and filterType #23 respectly where the range of filterIdx is 0 . . . 2.

Formulas for Dx and Dy as example for filterType #15, #2, #17, #24 are shown as follows:

For filterType #15, 2×2 filter is applied as follows

Dx=P[x][y]+P[x][y+1]−P[x+1][y]−P[x+1][y+1]

Dy=−P[x][y]−P[x+1][y]+P[x][y+1]+P[x+1][y+1]

For filterType #2, 3×3 filter is applied as follows

Dy=P[x−1][y+1]+2*P[x][y+1]+P[x+1][y+1]−P[x−1][y−1]−2*P[x][y−1]−P[x+1][y−1]

Dx=P[x−1][y−1]+2*P[x−1][y]+P[x−1][y+1]−P[x+1][y−1]−2*P[x+1][y]−P[x+1][y+1]

For filterType #17, 3×2 filter is applied as follows

Dy=P[x−1][y+1]+2*P[x][y+1]+P[x+1][y+1]−P[x−1][y]−2*P[x][y]−P[x+1][y]

Dx=2*P[x−1][y]+2*P[x−1][y+1]−2*P[x+1][y−1]−2*P[x+1][y+1]

For filterType #24, 2×3 filter is applied as follows

Dy=−2*P[x][y−1]−2*P[x+1][y−1]+2*P[x][y+1]+2*P[x+1][y+1]

Dx=P[x][y−1]+2*P[x][y]+P[x][y+1]−P[x+1][y−1]−2*P[x+1][y]−P[x+1][y+1]

For filterType #22, 4×4 filter is applied as follows

Dy=P[x−2][y+1]+P[x−1][y+1]+P[x][y+1]+P[x+1][y+1]+P[x−2][y]+P[x−1][y]+P[x][y]+P[x+1][y]−P[x−2][y−2]−P[x−1][y−2]−P[x][y−2]−P[x+1][y−2]−P[x−2][y−1]−P[x−1][y−1]−P[x][y−1]−P[x+1][y−1]

Dx=P[x−2][y−2]+P[x−2][y−1]+P[x−2][y]+P[x−2][y+1]+P[x−1][y−2]+P[x−1][y−1]+P[x−1][y]+P[x−1][y+1]−P[x][y−2]−P[x][y−1]−P[x][y]−P[x][y+1]−P[x+1][y−2]−P[x+1][y−1]−P[x+1][y]−P[x+1][y+1]

It is noted a 2×2 filter may use four positions of (x,y), (x+1, y), (x, y+1), (x+1,y+1) whereas a 3×3 filter may use nine positions of (x−1, y−1), (x, y−1), (x+1, y−1), (x−1, y), (x,y), (x+1, y), (x−1, y+1), (x, y+1), (x+1,y+1). 4×4 filter may use 16 positions of (x−2, y−2), (x−1, y−2), (x, y−2), (x+1, y−2), (x−2, y−1), (x−1, y−1), (x, y−1), (x+1, y−1), (x−2, y), (x−1, y), (x,y), (x+1,y), (x−2, y+1), (x−1, y+1), (x,y+1), (x+1,y+1). Similar 2×3 filter and 3×2 filter may use 6 positions (x, y−1), (x+1, y−1), (x,y), (x+1, y), (x, y+1), (x+1,y+1) and (x−1, y), (x,y), (x+1, y), (x−1, y+1), (x, y+1), (x+1,y+1) respectively. In general M×N filter may use (x+xx, y+yy), xx=−(M−1)/2 . . . M/2, yy=−(N−1)/2 . . . N/2. The signs of each component of the above equations may be reversed, i.e. the filters may be rotated by 180 degrees, which is also may be used for deriving gradient. In this case, Dx and Dy are derived using the following equations.

Rotating filterType #15 as example, rotated filter is applied as follows

Dx=−P[x+1][y]−P[x+1][y+1]+P[x][y]+P[x][y+1]

Dy=−P[x][y+1]−P[x+1][y+1]+P[x][y]+P[x+1][y]

Rotating filterType #2 as example, rotated filter is applied as follows

Dy=P[x−1][y−1]+2*P[x][y−1]+P[x+1][y−1]−P[x−1][y+1]−2*P[x][y+1]−P[x+1][y+1]

Dx=P[x+1][y−1]+2*P[x+1][y]+P[x+1][y+1]−P[x−1][y−1]−2*P[x−1][y]−P[x−1][y+1]

### Range for Gradient Derivation

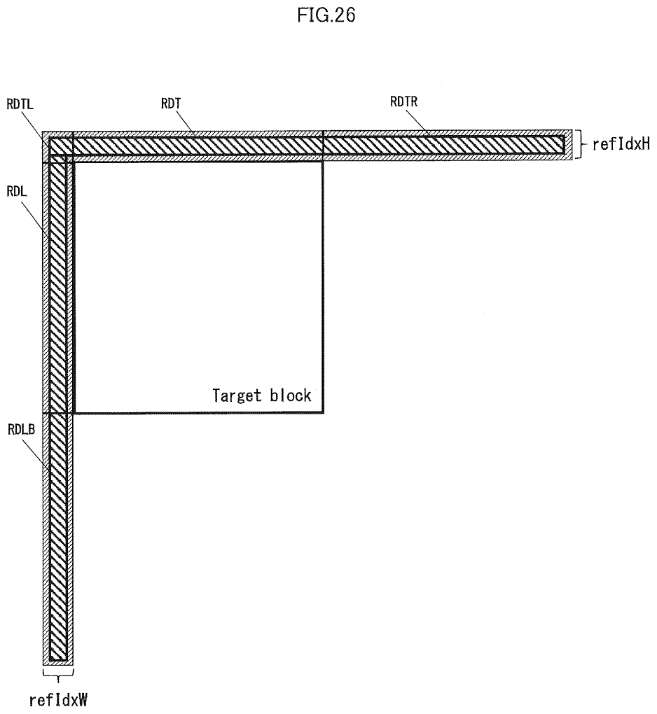

The position ranges (x,y) used for histogram counting which is used for deriving gradient are located in the reference regions RL, RT, RTL, RTR and RLB. The range (x,y) of the gradient derivation corresponding to RL, RT, RTL, RTR and RLB is referred to as RDL, RDT, RDTL, RDTR and RDLB which is showed in FIG. 26, FIG. 26 shows an example of 3×3 filter.

It is noted that the range of reference region should be larger than the range of gradient derivation if the applied filter size is taken account. e.g. 3 tap filter access, x−1, x, x+1 for position x. Thus the gradient derivation unit 310461 may change/extend the reference region depending on the derived filter size. Or the gradient derivation unit 310461 may change/reduce the gradient derivation region depending on the derived filter size.

For example, in a case the range of reference range is x=x0 . . . x1 and y=y0 . . . y1, the followings is applied.
(1) For a 3×3 filter, the range of gradient derivation may be x=x0+1 . . . x1-1 and y=y0+1 . . . y1−1 (by increasing start position by 1 and decreasing end position by 1 relative to the reference region).
(2) For a 2×2 filter, the range of gradient derivation may be x=x0 . . . x1−1 and y=y0 . . . y1−1 (by decreasing end position by 1 relative to the reference region).
(3) For a 4×4 filter, the range of gradient derivation may be x=x0+2 . . . x1−1 and y=y0+2 . . . y1−1 (by increasing start position by 2 and decreasing end position by 1 relative to the reference region).
(4) For a 3×2 filter, the range of gradient derivation may be x=x0+1 . . . x1−1 and y=y0 . . . y1−1.
(5) For a 2×3 filter, the range of gradient derivation may be x=x0 . . . x1−1 and y=y0+1 . . . y1−1.

In another example, in a case the reference range gradient derivation is x=x0 . . . x1 and y=y0 . . . y1, the followings is applied.
(1) For a 3×3 filter, the range of reference region may be x=x0-1 . . . x1+1 and y=y0−1 . . . y1+1.
(2) For a 2×2 filter, the range of reference region may be x=x0 . . . x1+1 and y=y0 . . . y1+1.
(3) For a 4×4 filter, the range of reference region may be x=x0-2 . . . x1+1 and y=y0−2 . . . y1+1.
(4) For a 3×2 filter, the range of reference region may be x=x0-1 . . . x+1 and y=y0 . . . y1+1.
(5) For a 2×3 filter, the range of reference region may be x=x0 . . . x1+1 and y=y0−1 . . . y1+1.

The gradient derivation unit 310461 derives the angular information composed of a angle quadrant of the texture of the target block and a angle within this quadrant according to the relationship of Dx and Dy. By using quadrant, the processing in some directions with rotational symmetry or line symmetry relationship may be unifized. However, angular information is not limited to quadrants and angles within quadrants. For example, angle information may be set as angle only, and the quadrants are derived as needed from this angle. In addition, in this embodiment, the derived intra direction prediction modes are limited to the direction from bottom-left to top-right (2 to 66 in FIG. 3), and the intra direction prediction modes in the 180 degree rotation symmetric direction are the same as this.

### Gradient Derivation Based on Quadrant

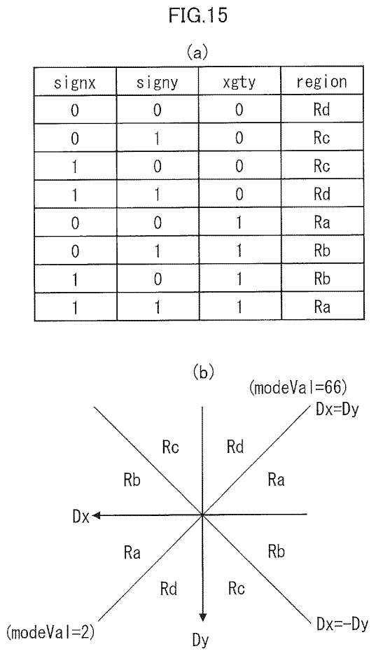

FIG. 15 (a) is a table shows the relationship of the sign (signx, signy), the size relationship xgty and the quadrant (Ra to Rd) of the Dx and Dy. FIG. 15 (b) shows the quadrants of Ra to Rd. The gradient derivation unit 310461 derives signx, signy, xgty as follows.

absx=abs(Dx)

absy=abs(Dy)

signx=Dx<0?1:0

signy=Dy<0?1:0

xgty=absx>absy?1:0

Here, unequal sign (>, <) may be replaced by (>=, <=). The angular information may be derived from the signx, signy, and xgty.

The gradient derivation unit 310461 derives the quadrant from the signx, signy, and xgty, using the following operation or table reference. The gradient derivation unit 310461 may refer to the table of FIG. 15(a) to derive the quadrant. The gradient derivation unit 310461 also may derives the quadrant by following formula.

quadrant=xgty?((signx\hat{ }signy)?1:0):((signx\hat{ }signy)?2:3)

The quadrant is represented by the value from 0 to 3, {Ra, Rb, Rc, Rd}={0, 1, 2, 3}. The value of the quadrant is not limited to the above.

### Angular Mode Derivation Device 310465

As described above, in this embodiment, the angular mode derivation device 310465 is used to derive the angular mode. It includes two parts: the gradient derivation unit 310461 and the angular mode derivation unit 310462. The gradient derivation unit 310461 is used to derive the gradient according to the pixel, and the angular mode derivation unit 310462 is used to derive the angle according to the gradient. Furthermore, in this embodiment, the filters and reference areas used in the gradient derivation unit 310461 may be changed based on the size and shape of the target block.

### Angular Mode Derivation Unit

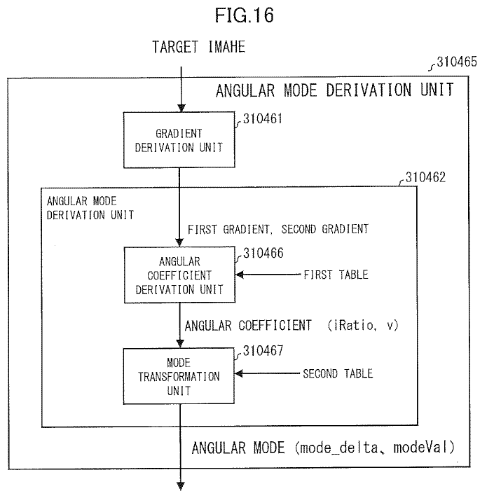

The angular mode derivation unit 310462 derives an angular mode (a prediction mode corresponding to the target block, for example, an intra prediction mode) based on the gradient information of the points P[x][y]. FIG. 16 is a block diagram showing one configuration of the angular mode derivation unit 310462. As shown in FIG. 16, the first gradient, the second gradient, and two tables are used to derive an angular mode(mode_delta or modeVal).

Derivation for Mode_Delta The angular mode derivation unit 310462 comprises an angular coefficient derivation unit 310466 and a mode transformation unit 310467. Angular coefficient derivation unit 310466 derives an angular coefficient iRatio (or v) based on two gradients. Here, the gradient iRatio (=absy÷absx) is derived based on the absolute value of the first gradient (absx) and the absolute value of the second gradient (absy). The iRatio may be represented by ratio and R_UNIT approximately as follows

iRatio=int(R_UNIT*absy/absx)≅ratio*R_UNIT

R_UNIT is the exponential power of 2 (1<<shiftR), e.g. R_UNIT=65536 when shiftR=16.

The method of deriving iRatio is described below, but deriving method is not limited to this example.

```
s0 = xgty ? absy : absx
  s1 = xgty ? absx : absy
  x = Floor( Log2( s1 ) )
  norm_s1 = (s1 << 4 >> x) & 15
  v = gradDivTable[norm_s1] | 8
  x += (norm_s1 != 0)
  shift = 13 − x
  if (shift < 0){
    shift = −shift
    add = (1 << (shift − 1))
    iRatio = (s0 * v + add) >> shift
  } else {
    iRatio = (s0 * v) << shift
  }
mode_delta = 16;
for( int i = 1; i < 17; i++ ){
if( iRatio <= angTable[i] ){
mode_delta = iRatio − angTable[i − 1] < angTable[i] − iRatio ? i − 1 : i;
break;
}
}
```

Here, gradDivTable={0, 7, 6, 5, 5, 4, 4, 3, 3, 3, 2, 1, 1, 1, 1, 0} and angTable={0, 2048, 4096, 6144, 8192, 12288, 16384, 20480, 24576, 28672, 32768, 36864, 40960, 47104, 53248, 59392, 65536}. In addition, in the expression, “|8” (OR calculation with 8) may be calculated by “+8”. Similarly, “|16”, “|32”, “|64” in the following description may be calculated with “+16”, “+32”, and “+64”, respectively.

x is a integer part of a logarithm value of third gradient value s1 (absx or absy) of a pixel. norm_s1 is derived by using the third gradient s1 to perform a shift operation of x. The angle coefficient v is determined by using norm_s1 and the reference table gradDivTable. Furthermore, iRatio is derived by the product of v and the fourth gradient s0 with shift operation based on x. Using iRatio and angTable to export angle mode mode_delta.

A clipping operation is performed in the following manner for making sure that the iRatio does not exceed the range of the numbers of angTable.

iRatio=min((s0*v)<<3>>x,N_LUT−1)

In addition, it is also appropriate to clip and make sure the value of s0*v not exceed a predetermined value KK. For example, not to exceed 32 bits. In this time, s0*v=(min(s0*v, KK)<<3)>>x, and KK=(1<<(31−3))−1=268435455. It is note that iRatio may be derived by reversing the definition of s0 and s1.
Derivation for modeVal

The mode transformation unit 310467 uses mode_delta to derive and output an angular mode modeVal.

modeVal=base_mode[quadrant]+direction[quadrant]*mode_delta

in where, base_mode [4]={HOR_IDX, HOR_IDX, VER_IDX, VER_IDX}, direction [4]={−1, 1, −1, 1}.

The number of occurrences of modeVal is recorded in a histogram (HistMode[ ]). The histogram may be calculated by adding 1 to the occurrence value corresponding to modeVal (This operation is referred to as “histogram counting” in subsequent sections of this document).

HistMode[modeVal]+=1

### Prediction Mode Selection Unit

The prediction mode selection unit 310463 derives one or more intra prediction modes dimdModeVal (dimdModeVal0, dimdModeVa1, dimdModeVal2, dimdModeVal3, dimdModeVal4) using the histogram HistMode[ ]. The histogram is derived by modeVal (modeVal) calculated by a plurality of points P which is belong to the gradient derivation target image. The dimdModeVal, in this embodiment, is the estimated value of the dominant texture direction of the target block. The dimdModeVal is derived by finding the most frequent value (mode value) in the histogram. In the histogram, the first mode dimdModeVal0 is derived by selecting a mode having the highest frequency (largest occurrence), and the second mode dimdModeVal1 is derived by selecting a mode having the second highest frequency (the second largest occurrence). In more detail, scan the HistMode[x] to give the x having maximum value in the HistMode to determine dimdModeVal0 (=argmax(HistMode)), and give the x having second maximum value in the HistMode to determine dimdModeVal1.

```
  maxVal = 0
  dimdModeVal0 = dimdModeVal1 = dimdModeVal2 = dimdModeVal3 =
dimdModeVal4 = −1
  for (x = 0; x < cntMode; x++) {
  if (HistMode[x] > maxVal) {
        maxVal = HistMode[x]
  dimdModeVal4 = dimdModeVal3
  dimdModeVal3 = dimdModeVal2
  dimdModeVal2 = dimdModeVal1
        dimdModeVal1 = dimdModeVal0
        dimdModeVal0 = x
      }
    }
```

Here, cntMode may be 67.

The method of deriving dimdModeVal0, dimdModeVal1, . . . is not limited to the histogram. For example, the prediction mode selection unit 310463 may set the mean value of modeVal to dimdModeVar0 or dimdModeVal1.

The prediction mode selection unit 310463 sets dimdModeVal2 a predetermined mode as the third mode. In this embodiment, the third mode is set equal to planar mode (0), but not limited to planar mode. Other modes may be adaptively set as third mode or the thirdthird mode may not be used.

The angular mode selection unit 310463 may derive weights of these three modes above-mentioned which are used in the prediction image generation unit 310464. The total weight is set to 64, and the weight of the third mode is assigned (W2=21), and the remainder is distributed to weights W0 and W1 in accordance with the ratio of the frequencies of the first and second modes in the histogram, respectively. The weighting of the first, second, and third modes is not limited to this, and the weights W0, W1, W2 of the first, second, and third modes may be changed. For example, W1 may be increased or decreased. It should be noted that the angle mode selection section sets a weight to 0 means the mode corresponding to this weight is not used.

The Configuration of Adaptive Gradient Derivation Unit 310461 and Angular Mode Derivation Unit 310465

As described above, in this embodiment, the reference region of the reference image used for deriving the intra prediction mode is changed in accordance with the dimd_mode. Specifically, the position of points P used in the gradient derivation unit 310461, the angle mode derivation unit 310462, and the angular mode selection unit 310463 are changed in accordance with the dimd_mode.

The position ranges (x,y) used for histogram counting for deriving gradient and angular mode are located in the reference regions RL, RT and RTL. For 3×3 filter, in the range for gradient deriving, the start point is made by increasing 1 and the end point is made by reducing 1. In case of 2×2 filter (filterIdx==0), in the range for gradient deriving, the start point is made without changing and the end point is made by reducing 1. That is, in case of 3×3 filter (filterIdx==1), if the reference range of dimd prediction is x=x . . . x1, y=y0 . . . y1, the range of gradient derivation may be x=x0+1 . . . x1−1, y=y0+1 . . . y1−1. In case of 2×2 filter (filterIdx==0), if the reference range of dimd prediction is x=x0 . . . x1, y=y0 . . . y1, the range of gradient derivation may be x=x . . . x1−1, y=y0 . . . y1−1. The range (x,y) of the gradient derivation corresponding to RL, RT and RTL is referred to as RDL, RDT, RDTL.

Example of Choosing Reference Area Base on dimd_mide

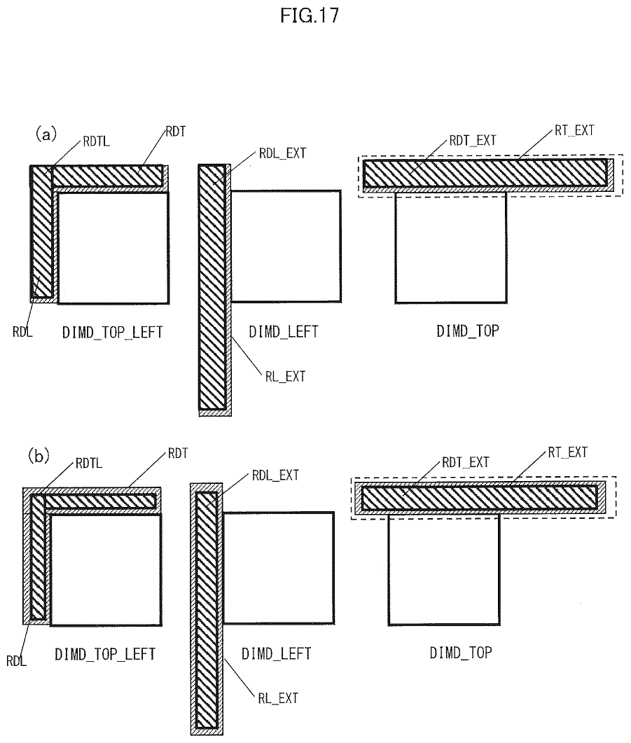

FIG. 17(b) shows an example of the reference range used in the processing of gradient derivation of the dimd prediction. In this case, the 3×3 filter (filterIdx==1) is used.

When dimd_mode==DIMD_MODE_TOP_LEFT, the angular mode derivation unit 310462 derives Dx and Dy from the each point P of the left region RDL of the target block, derives modeVal and conducts histogram counting operation. Subsequently, Dx and Dy are derived from each point P of the above region RDT of the target block, and modeVal is derived and histogram counting is conducted.

The area of RDL is x=−refIdxW . . . −2, y=−refIedxH . . . refH−2.

The area of RDT is x=−refIdxW . . . refW−2, y=−refIdxH . . . −2 RDTL is an area in which RDL and RDT are combined.

When dimd_mode==DIMD_MODE_LEFT, the angular mode derivation unit 310462 use the extension left region RDL_EXT of the target block, for example, Dx and Dy from the RDL_EXT, for deriving and counting modeVal.

The area of RDL_EXT is x=−refIdxW . . . −2, y=−refIedxH . . . refH*2−2.

When dimd_mode==DIMD_MODE_TOP, the angular mode derivation unit 310462 derives modeVal from the extension above region RDT_EXT of the target block, and conducts histogram counting.

The area of RDT_EXT is x=−refIdxW . . . refW*2−2, y=−refIdxH . . . −2

Here, refIdxW=2, refIedxH=2, refH=bH (the height of target block), refW=bW (the width of target block).

Similarly, for the cases using 2×2 filter, the reference region for gradient deriving is shown in FIG. 16(a).

In the cases using 2×2 filter:
The area of RDL is x=−refIdxW . . . −2, y=−refIedxH . . . refH−2
The area of RDT is x=−refIdxW . . . refW−2, y=−refIdxH . . . −2
RDTL is an area in which RDL and RDT are combined.
The area of RDL_EXT is x=−refIdxW . . . −2, y=−refIedxH . . . refH*2−2
The area of RDT_EXT is x=−refIdxW . . . refW*2−2, y=−refIdxH . . . −2
   Here, refIdxW=2, refIdxH=2, refH=bH (the height of target block), refW=bW (the width of target block).

The prediction mode selection unit 310463 selects an intra prediction mode from a plurality of angular modes derived by pixels in the gradient derivation target image, thus, can obtain an angular mode with higher accuracy. As described above, the prediction mode selection unit 310463 selects the angular mode estimated from the gradient and outputs with the weight corresponding to each angular mode.

### Prediction Image Generation Unit 310464

The prediction image generating unit 310464 generates a prediction image using two or three intra prediction mode, one of them is set as planar mode, other one or two intra prediction mode is angular mode input from the angular mode selection unit 310463. First, prediction images (pred0, pred1, pred2) according to each intra prediction mode are generated. Second, these prediction images are synthesized using corresponding weights (w0, w1, w2), and outputted as a prediction image q[x][y]. The prediction image q[x][y] is derived as follows.

q[x][y]=(w0*pred0[x][y]+w1*pred1[x][y]+w2*pred2[x][y])>>6

However, if the frequency of the third mode is 0 or is not the direction prediction mode (for example DC mode (presentive number is 1), etc.), the prediction image q[x][y] is generated by the first and second mode as follows.

q[x][y]=(w0*pred0[x][y]+w1*pred1[x][y])>>6

Here, the first and second mode is angular mode, the third mode is plannar mode. The w1 is 21 and the sum of w0 and w2 is 43, if w2 is 0, then w0 is 43.

It can also be written as follows.

The prediction image generating unit 310464 generates a prediction image using the intra prediction mode derived in Angular mode derivation device 310465. The prediction image generating unit 310464 may generates a prediction image q[x][y] using derived intra prediction in the angular mode derivation device 310465.

q[x][y]=w0*pred0[x][y]

The prediction image generating unit 310464 may generates a prediction image q[x][y] using two intra prediction mode derived in the angular mode derivation device 310465.

q[x][y]=(w0*pred0[x][y]+w1*pred1[x][y]+32)>>6

The prediction image generating unit 310464 may generates a prediction image q[x][y] using one or more more intra prediction mode derived in the angular mode derivation device 310465.

q[x][y]=(w0*pred0[x][y]+w1*pred1[x][y]+wP*predP[x][y]+321>>6

where pred0, pred1 and predP is the prediction image with IntraPredModeY being dimdModeVal0, prediction image with IntraPredModeY being dimdModeVal1, and prediction image with IntraPredModeY being planar mode.

The prediction image generating unit 31046 may derive weights of dimdModeVal0, dimdModeVal1 and planar mode as w0, w1 wP. The weight w0 and w1 is derived using the ratio of the occurrence of the first and second modes in the histogram, HistMode[dimdModeVal0] and HistMode[dimdModeVal1]. wP may be set equal to 21. The weighting of the first, second, and third modes is not limited to this. For example, w1 may be increased or decreased.

In generalized, the prediction image generating unit 310464 may generate a prediction image using one or more more intra prediction mode. Here the number of intra prediction mode N may be 2 to 6. one of them may be set as planar mode, other intra prediction modes are angular mode derived in the angular mode derivation device 310465. First, prediction images (pred0, pred1, pred2, pred3, pred4, predP) according to each intra prediction mode are generated. Second, these prediction images are synthesized using corresponding weights (w0, w1, w2, w3, w4, wP), and output as a prediction image q[x][y]. The prediction image q[x][y] is derived as follows.

q[x][y]=(w0*pred0[x][y]+w1*pred1[x][y]+w2*pred2[x][y]+w3*pred3[x][y]+w4*pred4[x][y]+wP*predP[x][y]+32)>>6

Here, the sum of weights is 64.
where pred2, pred3, pred4 is the prediction image with IntraPredModeY being dimdModeVal2, dimdModeVal3, dimeModeVal4.

If the occurrence of the dimd mode is 0 (dimdModeVal1==−1 or dimdModeVal2==−1 or dimdModeVal3==−1 or dimeModeVal4==−1), the prediction image q[x][y] is generated using derived intra prediction modes less than 5. Specifically, if the occurrence of the dimd mode is 1 or dimdModeVal1==−1, N=2 is used. Similar the occurrence of the dimd mode is 2, 3, 4 or dimdModeVal2−1, dimdModeVal1==−3, dimdModeVal1==−4, N=3, 4, 5 is used.

The prediction image may be generated by 2, 3 4 or 5 intra prediction modes, the prediction image q[x][y] is derived as follows.

q[x][y]=(w0*pred0[x][y]+wP*predP[x][y]+32)>>6

q[x][y]=(w0*pred0[x][y]+w1*pred1[x][y]+wP*predP[x][y]+32)>>6

q[x][y]=(w0*pred0[x][y]+w1*pred1[x][y]+w2*pred2[x][y]+wP*predP[x][y]+32)>>6

q[x][y]=(w0*pred0[x][y]+w1*pred1[x][y]+w2*pred2[x][y]+w3*pred3[x][y]+wP*predP[x][y]+32)>>6

Here, the last mode may be planar mode others may be angular modes.

The followings are detailed explanation for DIMD CHROMA prediction unit 31047.

DIMD CHROMA prediction unit 31047 generate a chroma prediction image. The ChromaFusionFlag is used to indicate whether the current target block uses the DIMD CHROMA method for chroma intra prediction. If ChromaFusionFlag is 1, the DIMD CHROMA prediction unit 31047 derives an angular mode indicating the texture direction in the neighboring region by pixel value. This angular mode will be used to generate the chroma prediction image.

### Reference Sample Derivation Unit

A reference sample derivation unit 310470 derives a reference sample refUnit from the previously decoded pixel recSamples adjacent to the target block. In an embodiment, the reference sample of DIMD CHROMA may includes luma components in addition to chromaponponent, Cb or Cr.

The reference sample derivation unit 310470 may refer one or more reference areas in chroma: e.g. left, top, top-left, top-right, and left-bottom areas of the target block in chroma (Cb or Cr) components. The regions are referred as RTL_cr, RT_cr, RL_cr, RTR_cr, and RLB_cr for Cr region and RTL_cb, RT_cb, RL_cb, RTR_cb, and RLB_cb for Cb region. Also the reference sample derivation unit 310470 may refer one or more luma reference areas in luma: e.g. left, top, top-left, top-right, and left-bottom areas adjacent of the target block (RTL, RT, RL, RTR, and RLB) and the target block in luma component (RLTAR). The derivation method of the left, top, top-left, top-right, and bottom-left samples of the target block is the same for the DIMD CHROMA and DIMD methods. The specific methods are described in DIMD prediction and will not be repeated here.

The reference sample derivation unit 310470 may refer a prediction image of the luma target block denoted as RLTAR (region of luma target block). It is noted that when generating the chroma prediction image, the prediction image of the luma target block has already been generated, so the pixels in the luma target block may also be used to generate the chroma prediction image. To obtain the pixels of the RLTAR, the following process may be performed at a position (x,y) located at the top-left corner of the target luma block:

refUnit[x/SubWidthC][y/SubHeightC]=recSamples[(xC+x)/SubWidthC][(yC+y)/SubHeight]

Here, x=0 . . . bW−1, y=0 . . . bH−1, where bW and bH are the width and height of the target luma block. (xC, yC) is the top left coordinate of the luma target block. The variables SubWidthC and SubHeightC are variables depending on the chroma format sampling structure where a chroma_format_idc syntax may be decoded from or encoded into a bitsteam. If chroma_format_idc is 0 as 4:2:0, (SubWidthC, SubHeightC)=(2,2). If chroma_format_idc is 2 as 4:2:2, (SubWidthC, SubHeightC)=(2,1). If chroma_format_idc is 3 as 4:4:4, (SubWidthC, SubHeightC) (1,1).

It's noted that the reference regions used in the DIMD CHROMA method may vary. The reference sample derivation unit 310470 in embodiment A, B, and C may refer chroma regions only, chroma regions plus luma regions, and chroma and luma and luma prediction regions, respectively. The embodiment is utilized depending on performance-complexity balance. Low complexity case may use A, medium complexity case may use B and high complexity but high performance case may uses C.

The specific selection of which reference regions to be used may be determined based on the target block. For example, the reference area may be selected according to the size of the target block as described in 310460.

### Angular Mode Derivation Device 310475

The angular mode derivation device 310475 is used to derive the angular mode. It includes two parts: the gradient derivation unit 310471 and the angular mode derivation unit 310472. The gradient derivation unit 310471 is used to derive the gradient according to the pixel, and the angular mode derivation unit 310472 is used to derive the angle according to the gradient. Furthermore, the filters and reference areas used in the gradient derivation unit 310471 may be changed based on the size and shape of the target block.

### Gradient Derivation Unit

The gradient derivation unit 310471 is the same as the gradient derivation unit 310461 but is applied for the chroma reference regions, the luma reference regions and the luma prediction image (luma target region). It derives gradient values in two or more specific directions (for example, Dx and Dy) for each regions based on pixel values of the regions of the target block, and derives angular information that represents a direction of texture patterns from the gradient values for each regions.

### Angular Mode Derivation Unit

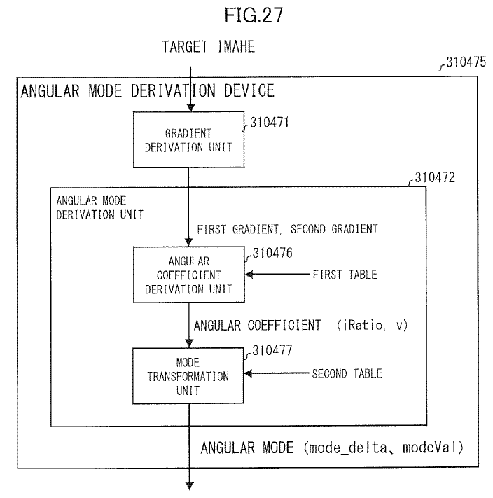

An angular mode derivation unit 310472 derives an angular mode (modeVal) based on the gradient information of the points P[x][y]. FIG. 27 is a block diagram showing one configuration of the angular mode derivation unit 310472. Because the angular mode derivation unit 310472 is the same as the angular mode derivation unit 310462, details is omitted.

### Angular Mode Selection Unit

A prediction mode selection unit 310473 derives one or more angular modes dimdChromaModeVal (dimdchromamodeVal0, dimdchromamodeVal1, . . . ) using the histogram derived by modeVal calculated by a plurality of points P which is belong to the gradient derivation target image. Because the prediction mode derivation unit 310473 is the same as the prediction mode selection unit 310463, details is omitted.

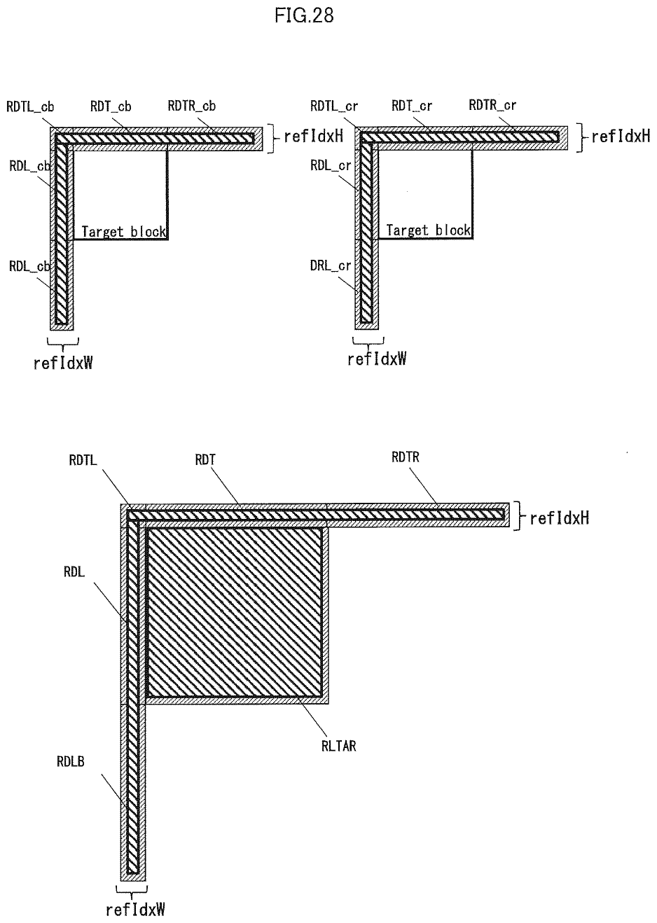

For referring the luma component, the position ranges (x,y) used for histogram counting to derive the gradient are located in the reference regions RL, RT, RTL, RTR, RLB, and RLTAR. The range of the gradient derivation corresponding to RL, RT, RTL, RTR, RLB, and RLTAR are referred to as RDL, RDT, RDTL, RDTR, RDLB, and RDLTAR as shown in FIG. 28.

For referring the chroma (Cb) component, the position ranges (x,y) used for histogram counting to derive the gradient and the angular mode are located in the reference regions RL_cb, RT_cb, RTL_cb, RTR_cb, and RLB_cb. The range of the gradient derivation corresponding to RL_cb, RT_cb, RTL_cb, RTR_cb, and RLB_cb are referred to as RDL_cb, RDT_cb, RDTL_cb, RDTR_cb, and RDLB_cb as shown in FIG. 28.

The chroma (Cr) component is the same as chroma (Cb) component, and the range (x,y) of the gradient derivation corresponding to RL_cr, RT_cr, RTL_cr, RTR_cr, and RLB_cr are referred to as RDL_cr, RDT_cr, RDTL_cr, RDTR_cr, and RDLB_cr as shown in FIG. 28.

The correspondence between the range for gradient derivation and the filter used is explained in Range for gradient derivation.

The prediction mode selection unit 310473 has the function that is selecting an angular mode from a plurality of angular modes derived by pixels in the gradient derivation target image, thus, may obtain an angular mode with higher accuracy. As described above, the prediction mode selection unit 310473 selects the angular mode estimated from the gradient and outputs with the weight corresponding to each angular mode.

### Prediction Image Generation Unit 310474

The prediction image generating unit 310474 generates a chroma prediction image using the chroma intra prediction mode derived in angular mode derivation device 310475. The prediction image generating unit 310474 may generates a chroma prediction image q[x][y] using derived chroma intra prediction in the angular mode derivation device 310475.

q[x][y]=w0*pred0[x][y]

The prediction image generating unit 310474 may generates a chroma prediction image q[x][y] using two chroma intra prediction mode derived in the angular mode derivation device 310475.

q[x][y]=(w0*pred0[x][y]+w1*pred1[x][y]+32)>>6

The prediction image generating unit 310474 may generates a chroma prediction image q[x][y] using one or more more chroma intra prediction mode derived in the angular mode derivation device 310475.

q[x][y]=(w0*pred0[x][y]+w1*pred1[x][y]+wP*predP[x][y]+32)>>6
where pred0, pred1 and predP is the chroma prediction image with IntraPredModeC being dimdModeVal0, and chroma prediction image with IntraPredModeC being dimdModeVal1, and chroma prediction image with IntraPredModeC being planar mode.
   The prediction image generating unit 310474 may generates a chroma prediction image q[x][y] using one or more more chroma intra prediction mode derived in the angular mode derivation device 310475.

q[x][y]=(w0*pred0[x][y]+w1*predLM[x][y]+32)>>6

where predLM is the prediction image with IntraPredModeC being CCLM (cross component linear model), MMLM (multi mode linear model). CCLM is a prediction mode in which the chroma prediction image is generated by linear operation with luma component value, e.g. predC=(a*luma+b)>>shift. Here predC is a prediction image value of the target block and a, b, shift is integer variables. It is noted that linear model parameter (a, b, and shift) is derived from nonboring chroma pixel value and luma pixel value of the target block. MMLM is a prediction mode in which combination of CCLM mode is utilized. Specifically in MMLM mode, two set of model parameter (a0, b0, shift0) and (a1, b1, shift1) are derived and models are selected by the corresponding luma value. e.g. predC=(a*luma+b)>>shift where (a, b, shift)=(a0, b0, shift0) if luma<thred otherwise (a, b, shift)=(a1, b1, shift1).

The inverse quantization and inverse transform processing unit 311 performs inverse quantization on a quantization transform coefficient input from the prediction parameter derivation unit 320 to calculate a transform coefficient. This quantization transform coefficient is a coefficient obtained by performing a frequency transform such as a Discrete Cosine Transform (DCT), a Discrete Sine Transform (DST), or the like on prediction errors to quantize in coding processing. The inverse quantization and inverse transform processing unit 311 performs an inverse frequency transform such as an inverse DCT, an inverse DST, or the like on the calculated transform coefficient to calculate a prediction error. The inverse quantization and inverse transform processing unit 311 outputs the prediction error to the addition unit 312.

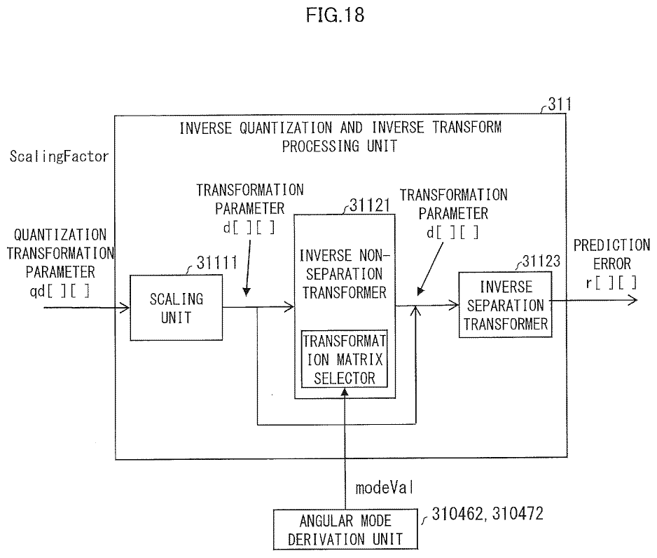

FIG. 18 is a block diagram showing the configuration of the inverse quantization and inverse transform processing unit 311 of this embodiment. The inverse quantization and inverse transform processing unit 311 comprises a scaling unit 31111, an inverse non separation transformer 31121 and a inverse separation transformer 31123. The inverse quantization and inverse transform processing unit 311 transforms transformation coefficients which are decoded from the coded data by using the angular mode derived by the angular mode derivation device 310465.

The inverse quantization and inverse transform processing unit 311 obtains transformation coefficient d[ ][ ] by using in scaling unit 31111 to scale the the quantization conversion coefficient qd[ ][ ] inputted from the prediction parameter derivation unit 320. The quantization transformation coefficient qd[ ][ ] is the coefficients obtained from the quantizing processing. Quantizing operation is performed by doing the DCT (Discrete Cosine Transform) or DST (Discrete Sine Transform) or the like transformation operation to the prediction error in the coding process. In some cases, non separation transform may be performed for obtaining the quantization transformation coefficient qd[ ][ ]. If the non separation transformation flag Ifnst_idx !=0, the inverse quantization and inverse transform processing unit 311 performs the inverse non-separation transformation by inverse non-separation transformer 31121. Further, the inverse quantization and inverse transform processing unit 311 refers to the transformation coefficients to perform inverse frequency transformation such as inverse DCT and inverse DST, and calculates the prediction error. If the non separation transformation flag Ifnst_idx !=0, then an inverse frequency transformation such as inverse DCT and inverse DST is calculated directly, the prediction error is calculated without using inverse non-separation transformer 31121. The inverse quantization and inverse transform processing unit 311 outputs the prediction error to the adding unit 312.

The addition unit 312 adds the prediction image of the block input from the intra prediction image generation unit 310 and the prediction error input from the inverse quantization and inverse transform processing unit 311 for each pixel and generates a decoded image of the block. The addition unit 312 stores the decoded image of the block in the reference picture memory 306 and outputs the image to the loop filter 305.

### Configuration of Video Coding Apparatus

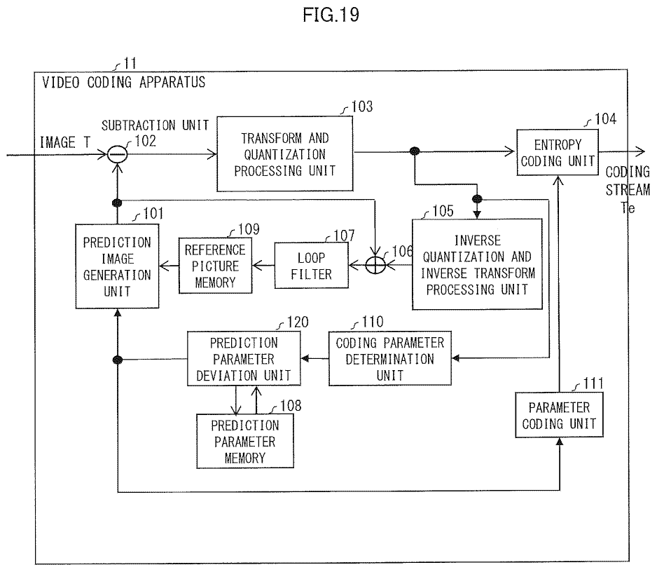

Next, a configuration of the video coding apparatus 11 according to the present embodiment will be described. FIG. 19 is a block diagram illustrating a conuration of the video coding apparatus 11 according to the present embodiment. The video coding apparatus 11 is configured to include a prediction image generation unit 101, a subtraction unit 102, a transform and quantization processing unit 103, an inverse quantization and inverse transform processing unit 105, an addition unit 106, a loop filter 107, a prediction parameter memory (a prediction parameter storage unit, a frame memory) 108, a reference picture memory (a reference image storage unit, a frame memory) 109, a coding parameter determination unit 110, a parameter coding unit 111, prediction parameter derivation unit 120, and an entropy coding unit 104.

The prediction image generation unit 101 generates a prediction image for each CU that is a region obtained by splitting each picture of the image T. The operation of the prediction image generation unit 101 is the same as that of the intra prediction image generation unit 310 already described, and thus descriptions thereof will be omitted.

The subtraction unit 102 subtracts a pixel value of the prediction image of the block input from the prediction image generation unit 101 from a pixel value of the image T to generate a prediction error. The subtraction unit 102 outputs the prediction error to the transform and quantization processing unit 103.

The transform and quantization processing unit 103 calculates a transform coefficient by performing a frequency transform on the prediction error input from the subtraction unit 102, and derives a quantization transform coefficient by quantization. The transform and quantization processing unit 103 outputs the quantization transform coefficient to the entropy coding unit 104 and the inverse quantization and inverse transform processing unit 105.

The inverse quantization and inverse transform processing unit 105 is the same as the inverse quantization and inverse transform processing unit 311 (FIG. 4) in the video decoding apparatus 31, and descriptions thereof are omitted. The calculated prediction error is output to the addition unit 106.

To the entropy coding unit 104, the quantization transform coefficient is input from the transform and quantization processing unit 103, and coding parameters are input from the parameter coding unit 111. The entropy coding unit 104 performs entropy coding on split information, the prediction parameters, the quantization transform coefficient, and the like to generate and output the coding stream Te.

The parameter coding unit 111 instructs the entropy coding unit 104 to encode the prediction parameters and quantization coefficients, derived from the prediction parameter derivation unit 120.

The prediction parameter derivation unit 120 derives the syntax element from the parameters inputted from the coding parameter determination unit 110. Some parts of the prediction parameter derivation unit 120 have the same structure as the prediction parameter derivation unit 320.

The addition unit 106 adds a pixel value of the prediction image of the block input from the prediction image generation unit 101 and the prediction error input from the inverse quantization and inverse transform processing unit 105 to each other for each pixel, and generates a decoded image. The addition unit 106 stores the generated decoded image in the reference picture memory 109.

The loop filter 107 applies a deblocking filter, an SAO, and an ALF to the decoded image generated by the addition unit 106. Note that the loop filter 107 need not necessarily include the above-described three types of filters, and may have a configuration of only the deblocking filter, for example.

The prediction parameter memory 108 stores the prediction parameters generated by the prediction parameter derivation unit 120 for each target picture and CU at a predetermined position. It may stores the transform coefficients created by the transform and quantization processing unit 103.

The reference picture memory 109 stores the decoded image generated by the loop filter 107 for each target picture and CU at a predetermined position.

The coding parameter determination unit 110 selects one set among multiple sets of coding parameters. A coding parameter refers to the above-mentioned QT, BT, or TT split information, the prediction parameter, or a parameter to be coded, the parameter being generated in association therewith. The prediction image generation unit 101 generates the prediction image by using these coding parameters.

The coding parameter determination unit 110 calculates, for each of the multiple sets, an RD cost value indicating the magnitude of an amount of information and a coding error. The RD cost value is, for example, the sum of a code amount and the value obtained by multiplying a coefficient k by a square error. The coding parameter determination unit 110 selects a set of coding parameters of which cost value calculated is a minimum value. With this configuration, the entropy coding unit 104 outputs the selected set of coding parameters as the coding stream Te. The coding parameter determination unit 110 outputs the determined coding parameters in the parameter coding unit 111, the prediction parameter derivation unit 120, the prediction image generation unit 101.

Note that, some of the video coding apparatus 11 and the video decoding apparatus 31 in the above-described embodiment, for example, the entropy decoding unit 301, the parameter decoding unit 302, the loop filter 305, the intra prediction image generation unit 310, the inverse quantization and inverse transform processing unit 311, the addition unit 312, the prediction parameter derivation unit 320, the prediction image generation unit 101, the subtraction unit 102, the transform and quantization processing unit 103, the entropy coding unit 104, the inverse quantization and inverse transform processing unit 105, the loop filter 107, the coding parameter determination unit 110, and the parameter coding unit 111, the prediction parameter derivation unit 120, may be realized by a computer. In that case, this configuration may be realized by recording a program for realizing such control functions on a computer-readable recording medium and causing a computer system to read the program recorded on the recording medium for execution. Note that the “computer system” mentioned here refers to a computer system built into either the video coding apparatus 11 or the video decoding apparatus 31 and is assumed to include an OS and hardware components such as a peripheral apparatus. Furthermore, a “computer-readable recording medium” refers to a portable medium such as a flexible disk, a magneto-optical disk, a ROM, a CD-ROM, and the like, and a storage device such as a hard disk built into the computer system. Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a fixed period of time, such as a volatile memory included in the computer system functioning as a server or a client in such a case. Furthermore, the above-described program may be one for realizing some of the above-described functions, and also may be one capable of realizing the above-described functions in combination with a program already recorded in a computer system.

Furthermore, a part or all of the video coding apparatus 11 and the video decoding apparatus 31 in the embodiment described above may be realized as an integrated circuit such as a Large Scale Integration (LSI). Each function block of the video coding apparatus 11 and the video decoding apparatus 31 may be individually realized as processors, or part or all may be integrated into processors. The circuit integration technique is not limited to LSI, and the integrated circuits for the functional blocks may be realized as dedicated circuits or a multi-purpose processor. In a case that with advances in semiconductor technology, a circuit integration technology with which an LSI is replaced appears, an integrated circuit based on the technology may be used.

The embodiment of the present disclosure has been described in detail above referring to the drawings, but the specific configuration is not limited to the above embodiments and various amendments may be made to a design that fall within the scope that does not depart from the gist of the present disclosure.

The embodiment of the present invention may be applied to a video decoding device that decodes encoded data of image data, and a video encoding device that generates encoded data from image data. In addition, the data structure of the encoded data is generated by the video encoding device and referenced by the video decoding device.

### REFERENCE SIGNS LIST

31 Image decoding apparatus
301 Entropy decoding unit
302 Parameter decoding unit
310 Prediction image generation unit
3104 Intra prediction unit
31046 Dimd prediction unit
310460 Reference sample derivation unit
310465 Angular mode derivation device
310461 Gradient derivation unit
310462 Angular mode derivation unit
310463 Prediction mode selection unit
310464 Prediction image generation unit
31047 DIMD CROMA prediction unit
310470 Reference sample derivation unit
310475 Angular mode derivation device
310471 Gradient derivation unit
310472 Angular mode derivation unit
310473 Prediction mode selection unit
310474 Prediction image generation unit
311 Inverse quantization and inverse transform processing unit
312 Addition unit
11 Image coding apparatus
101 Prediction image generation unit
102 Subtraction unit
103 Transform and quantization processing unit
104 Entropy coding unit
105 Inverse quantization and inverse transform processing unit
107 Loop filter
110 Coding parameter determination unit
111 Parameter coding unit

1. An image decoding apparatus comprising:
reference sample derivation circuitry that derives reference samples adjacent to a target block;
gradient derivation circuitry that derives gradients from the reference samples by using one of a plurality of gradient filters selected according to a size of the target block;
angular mode derivation circuitry that derives an intra prediction mode based on the gradients; and
prediction circuitry that generates a prediction block by using the intra prediction mode.

2. The image decoding apparatus according to claim 1, wherein
the gradient derivation circuitry changes a size of filters according to a width and a height of the target block.

3. The image decoding apparatus according to claim 1, wherein
the gradient derivation circuitry determines a gradient filter having a smaller size among the plurality of gradient filters, in a case the target block is small.

4. The image decoding apparatus according to claim 1, wherein
the gradient derivation circuitry changes a size of filters used according to a dimd_mode.

5. The image decoding apparatus according to claim 1, wherein
the gradient derivation circuitry determines a smaller filter in a case that a dimd_mode indicates both a top neighboring block and a left neighbor block are used.

6. An image encoding apparatus comprising:
reference sample derivation circuitry that derives reference samples adjacent to a target block;
gradient derivation circuitry that derives gradients from the reference samples by using one of a plurality of gradient filters selected according to a size of the target block;
angular mode derivation circuitry that derives an intra prediction mode based on gradients;
prediction circuitry that generates a prediction block by using the intra prediction mode.

7. (canceled)

8. The image decoding apparatus according to claim 1, wherein
the gradient derivation
circuitry selects a filter of a target block and
derives the gradients by using pixels of a neighboring image and the filters.

9. The image decoding apparatus according to claim 1, wherein
the gradient derivation
circuitry determines a different weight of central elements in a 3×3 filter depending on the size of the target block.

10. The image decoding apparatus according to claim 9, wherein
the gradient derivation
circuitry determines the weight of the central elements in the 3×3 filter such that it firstly decreases and secondly increases as the size of the target block increases.

11. The image decoding apparatus according to claim 1, wherein
the gradient derivation
circuitry changes a size of filters according to the size of target block.

12. The image decoding apparatus according to claim 1, wherein
the gradient derivation
circuitry changes a shape of filters according to the size of target block.

13. The image decoding apparatus according to claim 1, wherein
the gradient derivation circuitry changes a shape of filters according to a shape of target block.

14. (canceled)

15. A non-transitory computer-readable storage medium storing a bitstream,
the bitstream comprising information for intra prediction of a target block,
wherein the information being for:
deriving reference samples adjacent to the target block;
deriving gradients from the reference samples by using one of a plurality of gradient filters selected according to a size of the target block;
deriving an intra prediction mode based on the gradients; and
generating a prediction block by using the intra prediction mode.
